(19) United States
(12) Patent Application Publication
(10) Pub. No.: US 2022/0308720 A1
(43) Pub. Date: Sep. 29, 2022

(54) DATA AUGMENTATION AND INTERFACE FOR CONTROLLABLE PARTITIONED SECTIONS

(71) Applicant: MashApp, Inc., San Francisco, CA (US)

(72) Inventors: Sergey Korzhenevich, Hermosa Beach, CA (US); Yuriy Motin, Mountain View, CA (US); Sergey Dmitrievich Rudovskiy, Tashkent (UZ); Aleksandr Evgenevich Finogentov, Tbilisi (GE); Valeriy Nikolaevich Kharkov, Tivat Municipality (ME); Volodymyr Chekyrta, Chernomorsk (UA)

(21) Appl. No.: 17/704,543

(22) Filed: Mar. 25, 2022

Related U.S. Application Data
(60) Provisional application No. 63/166,902, filed on Mar. 26, 2021.
(60) Provisional application No. 63/285,593, filed on Dec. 3, 2021.

(51) Int. Cl. G06F 3/0484; G06F 3/0482; G06F 40/205

(52) U.S. Cl. CPC G06F 3/0484; G06F 3/0482; G06F 40/205; G06Q 30/0641

(57) ABSTRACT

A method includes obtaining a first item record and a linking record based on a shared feature value associated with the first item record, determining a first transformed record by populating a first feature of the first item record with a first value of the linking record, and obtaining a second transformed record. The method includes sending a set of feature values of the first and second transformed records to a device. The device performs operations including selecting the first feature based on a determination that first and second values of the first feature are different in response to selecting the first feature, instantiating a first set of UI elements to include the first value and a second set of UI elements to comprise the second value. Some embodiments may present the first set of UI elements and the second set of UI elements on a display screen.

### PRIORITY

This application claims priority to U.S. provisional application 63/166,902, filed Mar. 26, 2021, the entirety of which is incorporated herein by reference. This application further claims priority to 63/285,593, filed Dec. 3, 2021, the entirety of which is incorporated herein by reference.

### BACKGROUND

Modern web-based operations often benefit from retrieving and integrating disparate pieces of information distributed across a spectrum of public and private systems. In the realm of mobile device technology, such operations permit a single client-side mobile computing device to retrieve aggregated content of various types from multiple sources and efficiently visualize the content on a portable platform. However, the use of such devices presents unique challenges, such as limited screen space, limited processing power, and limited space for user inputs. Furthermore, the rise of modern video communications presents additional complexities with respect to information presentation that is accurate and does not require a significant cognitive load on the part of a user.

### SUMMARY

In the context of data collection and presentation, data obtained for presentation to a user may have been extracted from a third-party data source, transformed by performing one or more operations, and loaded into an application-compatible format. In many cases, the data extracted from the third-party data source may be inappropriate for presentation on a display screen or may fail to include values used by an application executing on a client computing device. Furthermore, presenting such information on a small display screen may result in user confusion and unnecessary consumption of mobile data resources by transmitting duplicative values. Operations to transform and augment the obtained data may increase the effectiveness and efficiency of data presentation on a client computing device.

Some embodiments may address the issues discussed above and other issues by transforming obtained data into a data format compatible with a set of modular user interface (UI) elements, such as a UI card. Some embodiments may augment the parsed data with information obtained from other records, such as location-specific records associated with a geographical location stored in the parsed data. Some embodiments may associate different item records or rows in a data table based on a shared identifier, a shared association with the same record or record value, or a shared user. For example, after first obtaining a. hotel room record that includes a geographical location of the hotel, some embodiments may obtain weather-specific or map-specific values associated with the geographical location. Some embodiments may then transform the obtained data into a transformed record based on values of different records, such as a first obtained record and a linking record that shares a value with the first obtained record. Some embodiments may generate a plurality of transformed records, where the transformed records may share some feature values and differ with respect to other feature values, and where differences in feature values may be used to select transformed records.

Some embodiments may determine feature differences between different records, where these differences may be used to select one or more features to display on a mobile computing device. Some embodiments may send a version of the set of feature values to a mobile computing device for card-based visualization operations. After receiving the set of feature values and associated flags at the mobile computing device, some embodiments may cause the mobile computing device to display a set of UI cards on a display screen of the mobile computing device, where the set of UI cards may include the set of feature values based on the associated flags. For example, some embodiments may highlight or otherwise visually indicate a feature value shown on UI cards, where the feature value is indicated as different between a set of records.

Various other aspects, features, and advantages of the invention will be apparent through the detailed description of the invention and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion,” refers to a part of, or the entirety of (i.e., the entire portion), a given item (e.g., data) unless the context clearly dictates otherwise. Furthermore, a “set” may refer to a singular form or a plural form, such as that a “set of items” may refer to one item or a plurality of items.

### BRIEF DESCRIPTION OF THE DRAWINGS

FIG. 1 shows an illustrative system for retrieving data from data sources and presenting the retrieved data in a set of cards, in accordance with one or more embodiments.

FIG. 2 shows an illustrative diagram of a UI and UI changes made in response to user interactions with the UI, in accordance with one or more embodiments.

FIG. 3 shows a conceptual diagram of a system infrastructure through which a presenting device may provide content to a viewing device, in accordance with one or more embodiments.

FIG. 4 shows a flowchart of a process to obtain item values, parse the item values based on a set of data templates, and present the item values in the form of UI cards, in accordance with one or more embodiments.

FIG. 5 shows a flowchart of a process to present UI cards based on interactions, in accordance with one or more embodiments.

FIG. 6 shows a flowchart of a process to present video streaming data to a viewing device, in accordance with one or more embodiments.

FIG. 7 shows a set of active UI cards, in accordance with one or more embodiments.

FIG. 8 shows a set of UI screens permitting control of inputs not accessible via a third-party system, in accordance with one or more embodiments, in accordance with one or more embodiments.

FIG. 9 shows a pair of UI screens with shareable lists of UI elements, in accordance with one or more embodiments.

FIG. 10 shows an additional set of interface screens permitting a user to see the various records generated by the user, in accordance with one or more embodiments.

FIG. 11 shows a set of streaming content interfaces, in accordance with one or more embodiments.

FIG. 12 shows a set of UI elements for the creation of UI cards, in accordance with one or more embodiments.

FIG. 13 shows a tabular representation of media-event stream data that occurs through a video presentation, in accordance with one or more embodiments.

FIG. 14 is a block diagram of a computer system as may be used to implement certain features of some of the embodiments.

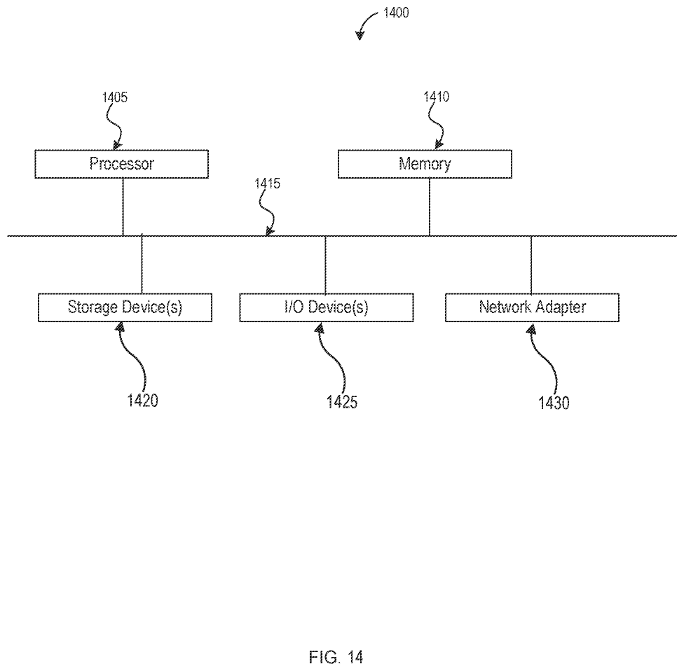

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

Some embodiments may obtain data from a data source that stores data in a tabular form. Some embodiments may obtain the data and transform the data into a tree structure or another transformed data structure to increase the speed or efficiency of data retrieval operations. For example, some embodiments may implement one or more algorithms to transform obtained data into a more visually compatible form with a user interface (UI) of an application. Furthermore, some embodiments may provide products in the form of cards among a sequence of cards, where each card may represent a product, a feature of the product, or other data related to the product. As used in this disclosure, a feature of a record may refer to attribute columns of the record as well as specific values of those attribute columns. For example, modifying a feature may include modifying a feature value or modifying a feature name, displaying a feature may include displaying feature name or feature value, a feature may include a value if a feature value for the feature includes the value, etc.

Some embodiments may augment data retrieved from a data source with parameters of a query used to retrieve the augmented data. Alternatively, or in addition, some embodiments may perform searches based on a determination that multiple items or versions of the same item may be required and, in response, obtain different combinations of the items. For example, some embodiments may send a query to a third-party data source that includes a count of individuals for a hotel room. After retrieving a set of data from the third-party data source, some embodiments may generate a record based on the third-party data source, where the record may be augmented to include one or more of the query parameters used to retrieve the data.

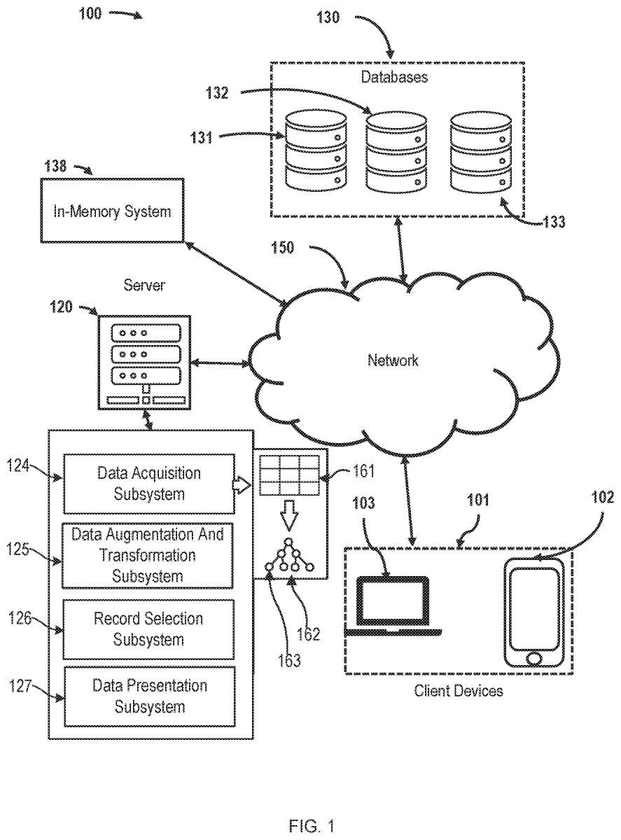

FIG. 1 shows an illustrative system for retrieving data from data sources and presenting the retrieved data in a set of cards, in accordance with one or more embodiments. A system 100 includes a set of client computing devices 101, which may include a mobile computing device 102 and a laptop computer 103. In some embodiments, set of client computing devices 101 may include other types of computer devices such as a desktop computer, a wearable headset, a smartwatch, another type of mobile computing device, etc. In some embodiments, one or more devices of the set of client computing devices 101 may communicate with various other computer devices via a network 150, where the network 150 may include the Internet, a local area network, a peer-to-peer network, etc.

The set of client computing devices 101 may send and receive messages through the network 150 to communicate with a server 120, where the server 120 may include non-transitory storage medium storing program instructions to perform one or more operations of subsystems 124-127. It should further be noted that, while one or more operations are described herein as being performed by particular components of the system 100, those operations may be performed by other components of the system 100 in some embodiments. For example, one or more operations described in this disclosure as being performed by the server 120 may instead be performed by some or all devices of the set of client computing devices 101.

In some embodiments, the set of computer systems and subsystems illustrated in FIG. 1 may include one or more computing devices having or otherwise capable of accessing electronic storage, such as the set of databases 130. The set of databases 130 may include relational databases, such as a SQL database. Alternatively, or in addition., the set of databases 130 may include a non-relational database, such as a MongoDB™ database, Neo4j™ database, another graph database, etc. Furthermore, some embodiments may communicate with an API of a third-party data service via the network 150 to obtain records of datasets or other data not stored in the set of databases 130 based on a query sent to the API. In addition, the set of client computing devices 101 or the server 120 may access data stored in an in-memory system 138, where the in-memory system may include an in-memory data store that stores data in a key-value data store such as Redis™. Some embodiments may store queries or query results associated with the queries in an in-memory data store to accelerate data retrieval operations.

In some embodiments, a dataset may include one or more records, where each dataset may include multiple records that share the same set of features. The dataset may include or otherwise be associated with a set of metadata. The metadata may include dataset names, feature names, a set of descriptors of the dataset as a whole, a set of descriptors for one or more specific features of the dataset, etc. Some embodiments may augment generated data trees or other records with the metadata. In some embodiments, the dataset may be visually depicted in a tabular form, such as in the form of a data table where the features may be represented by columns, and the records may be represented by rows. A record may include a set of features, where each feature of the record may be associated with the record and be retrievable based on an identifier of the record. For example, a record may include a first feature value “12345678” for a first feature “account value” and a second feature value “zb6958204” for a second feature “record identifier.”

In some embodiments, the set of client computing devices 101 may send a query that includes an input sequence via a message, such as a web request conforming to an established communication protocol (e.g., Hyper Text Transfer Protocol (HTTP), HTTP Secure (HTTPS), etc.). For example, the mobile computing device 102 may send a query to the server 120 in a message secured via HTTPS, where the server 120 may then retrieve records from the set of databases 130 based on the query.

### Subsystems 124-127

In some embodiments, the dataset acquisition subsystem 124 may retrieve a set of item data or other data from a data source, such as a third-party data source, an internal data source, etc. The data transformation subsystem 124 may obtain item data from a third-party data source via the network 150. The data transformation subsystem 124 may parse the obtain data into different sets of values corresponding with different sets of features. Each respective set of the set of features may correspond with a respective UI card. For example, the data transformation subsystem 124 may populate a first set of features corresponding with a first UI card with information associated with the price and location data of a first item and populate a second set of features corresponding with a second card with information associated with the time and weather data of the first item. As described elsewhere in this disclosure, multiple features may share values of the obtained data. For example, a first set of features may include a geographic location represented by a set of GPS coordinates, and a second set of features may include the geographic location represented by the set of GPS coordinates. Furthermore, a feature may include data from multiple values, such as by including the multiple values in an array for a feature, determining a sum of the multiple values, determining a function output that uses the multiple values as inputs, etc.

In some embodiments, the data augmentation and transformation subsystem 125 may populate one or more records or another set of values with additional data associated with queries used to obtain data stored in the records or other set of values. For example, some embodiments may use a query that includes the query parameter “guests>7” to obtain a first set of values from a data source. Some embodiments may then augment a record that includes the first set of values with the query parameter “guests>7.” Furthermore, some embodiments may obtain additional data based on a first set of obtained records. For example, some embodiments may obtain a record from a first third-party data source that includes a geographic location. Some embodiments may then retrieve additional information, such as weather information or geographic mapping information, from a second third-party data source based on the geographic location and associate this additional information with the record third-party data source.

After obtaining data, some embodiments may store the data as a set of retrieved records structured in a table 161. Some embodiments may then use the data augmentation and transformation subsystem 125 to determine feature similarities between different rows of a record and generate a tree 162, where each node of the tree 162 may represent a feature of the table 161. For example, a node 163 may represent a first hotel record feature such as a number of rooms or whether a minibar is available. Alternatively, or in addition, a node of the tree 162 may represent a query parameter used to augment a record or otherwise be based on the query parameter. In some embodiments, the query parameter may be based on business rules that improve user experiences or back-end processes. The incoming features of the table may be recognized, filtered, sorted, aggregated, de-duplicated, and stored in the tree 162. For example, some embodiments may provide a query parameter to an application program interface (API) indicating a geographic location, an association with a discount or reward program, an age of construction, or the like. Some embodiments may then use the query parameter or a threshold based on the query parameter to separate records of a retrieved set of records by finding a relevant node of the tree 162 mapped to the query parameter. After generating transformed data that includes the tree 162, some embodiments may store the transformed data in a data store of the set of databases 130. Some embodiments may use one or more query parameters as a part of the index values of an index used to quickly access data, such as initially obtained data or transformed data.

Some embodiments may use the data selection subsystem 126 to select records and record values based on differences between the records or other criteria. The criteria may include one or more query parameters provided by a user of the mobile computing device 102. Some embodiments may select a record based on feature differences between different records, where these differences may be used to select one or more features to display on a mobile computing device. For example, a system may determine that a rating score and a weather category between a first item record and a second item. record are identical and not include either feature in a first feature set. The system may then determine that distances from the respective geographical locations of the first and second item records to a target geographical location are different and, in response, associate an indicator with the feature of the different values. Some embodiments may send the feature or associated set of feature values to a client computing device, where the client computing device may visualize the set of feature values in the form of UI cards or other modular UI elements.

In some embodiments, the data presentation subsystem 127 may be used to present modular UI elements, such as a UI card. As used in this disclosure, the UI card may be presented to include an outer shape and content that is displayed within the outer shape. The outer shape may include a rectangle, a rounded rectangle, a geometric stadium, a polygon, an ovoid, or another shape. The content displayed within the outer shape may include images, numeric values, text, video data, widgets or other interactive UI elements, etc.

In some embodiments, the data presentation subsystem 127 may provide data to a device such as the mobile computing device 102 or another device of the set of client computing devices 101. For example, data presentation subsystem 127 may provide the mobile computing device 102 with program code or parameters that cause the mobile computing device 102 to present the content of multiple UI cards or other modular UI elements. For example, the data presentation subsystem 127 may provide program code to the client computer device 102 in the form of JavaScript code, where the computer device 102 may then compile or execute the JavaScript code in a web browser compiler to present a set of UI cards. Alternatively, or addition, the data presentation subsystem 127 may provide program instructions in other formats to the mobile computing device 102, where a native application executing on the mobile computing device 102 may interpret the program instructions to present the set of UI cards. The set of UI cards may include various types of cards. For example, the set of UI cards may include a first UI card that includes a representation of a geographical location and a second card that includes an expected time of arrival at the geographical location.

Some embodiments may display instantiated UI elements as interactive UI cards of a UI. For example, some embodiments may display a first interactive UI card at a first screen region and a second interactive UI card at a second screen region within 100 points of the first interactive UI card. In some embodiments, different types of user interactions with the interactive UI cards may cause different changes in the UI displayed by the mobile computing device. For example, some embodiments may display a first interactive UI card at a first screen region on a UI of an application executing on the mobile computing device. In response to detecting a substantially horizontal motion on the first interactive UI card, the application may move the first interactive UI card away from the first screen region and or move a second interactive UI card to the first screen region.

After receiving the set of feature values and associated indicators at a mobile computing device, some embodiments may select a feature to display or represent in a UI element based on the flag indicating different values. For example, some embodiments may select the feature “distance to target location” instead of “weather type” based on a determination that the feature “distance to target location” has differing feature values and that the feature “weather type” has the same value between the pair of item records. Some embodiments may then use program code of an application executing on the mobile computing device to cause the mobile computing device to display a set of UI cards on a display screen of the mobile computing device. For example, some embodiments may instantiate a first UI element representing a first item record or a transformed record based on the first item record. Similarly, some embodiments may instantiate a second UI element representing the second item record or a transformed record based on the second item record. Furthermore, some embodiments may determine which features of the UI elements to display based on the features selected for being associated with differing feature values. For example, a native app of a mobile computing device may configure a first UI card to display a first feature value and configure a second UI card to display a second feature value based on an indicator indicating that the first and second feature values are different.

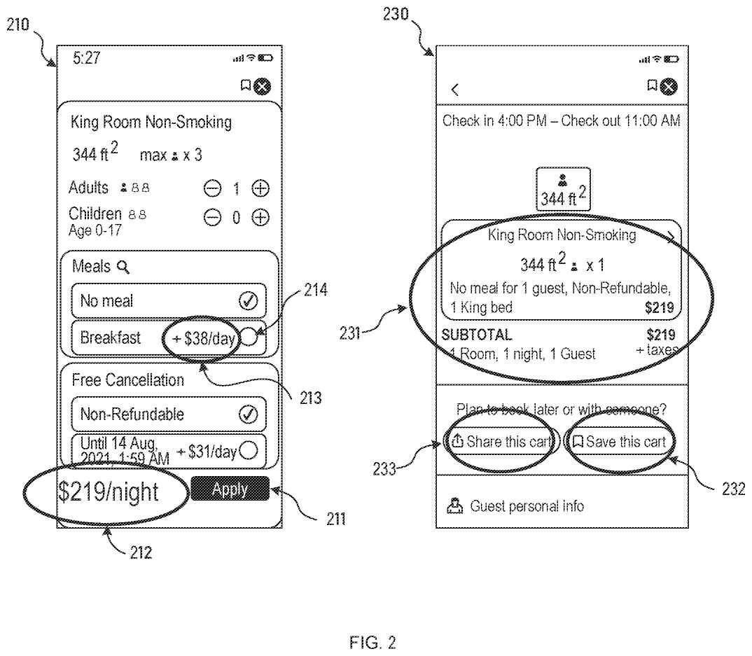

FIG. 2 shows an illustrative diagram of a UI and UI changes made in response to user interactions with the UI, in accordance with one or more embodiments. In some embodiments, a user may interact with a first UI screen 210, where the first UI screen 210 may display various types of information obtained from a data source. A user may perform interactions with the UI screen 210 to select requirements or other criteria for filtering records by using UI elements to determine the requirements for a filter. The UI elements may include radio buttons, other buttons, switches, dropdown menus, text entry boxes, or the like. In some embodiments, the UI elements may present representations of some or all possible criteria combinations available based on the features of a table or tree generated from obtained data. For example, some embodiments may generate a tree based on the obtained data and display a set of radio buttons or switches based on the nodes of the tree, where interactions with the radio buttons or switches may cause a system to traverse different paths of the tree such that any value of the obtained data may be displayed.

Some embodiments may determine one or more UI elements for a presentation of a UI screen by configuring a UI screen to show only the items that fit the criteria selected with the use of the UI screen. For example, a first UI screen 210 may detect the existence of a “breakfast” feature based on a tree having a node labeled with “breakfast,” where the tree may be generated from structured data obtained from a third-party data source. Some embodiments may then determine that “breakfast” is a permitted feature of the first UI screen 210 based on a set of criteria associated with the first UI screen 210. In response, some embodiments may present the numeric value 213 and the UI element 214, where a user's interaction with the III element 214 may cause some embodiments to update a variable that is then transmitted to a server to update a record after the user interacts with the interactive UI element 211, as described further below.

The first UI screen 210 may include an interactive UI element 211 and a set of values obtained from the third-party data source, such as the numeric value 213. Some embodiments may receive instructions to update a user-related record, a set of item records, or other records from a client computing device executing the first UI screen 210. Some embodiments may update a local version of a UI state to update a UI screen. For example, based on whether a user interacts with the UI element 214, some embodiments may update the numeric value 213 to increase or decrease the numeric value 213 by the amount “38.”

After interaction with the interactive UI element 211, some embodiments may present the UI screen, 230. As shown in the UI screen, 230, some embodiments may display additional information, such as information in the UI element 231, where the UI element 231 may display values obtained one or more of the updated records. For example, some embodiments may determine that a user had selected an item associated with the value “219” based on an item record updated by a message submitted from a client computing device. In response, some embodiments may display the value “219” and may further display associated features of the item record.

The item record or set of item records associated with a user may be associated with other users. For example, some embodiments may collect identifiers for a set of item records in a list of identifiers associated with one or more users to include the list of identifiers after a user interacts with the interactive UI element 233. Some embodiments may store the list of identifiers with a label, such as “cart,” where a user may interact with the UI element 232 to store the list of identifiers in a record in association with the user. In some embodiments, the list of identifiers may be shared with other users after a user interacts with the interactive UI element 233. For example, after detecting an interaction with the interactive UI element 233, some embodiments may obtain a list of other users and provide access to the list of identifiers to one or more users of the list of other users.

Some embodiments may provide a set of UI elements to another user that permits the other user to update identifiers or associate additional data with an item record of a record list of item records, such as the item record corresponding with the UI element 231. For example, an item record corresponding with the UI element 231 may be a record list that identifies one or more hotel rooms. Some embodiments may provide a UI element, such as a UI element labeled “Notes,” where any user having permission to access the list of identifiers may interact with the UI element to open a window to write comments, add images, or add other data to the record list. Some embodiments may provide the means for a public set of individuals to view or edit the comments, questions, or other information associated with an item record. Alternatively, some embodiments may restrict the set of users permissioned to view or edit the information associated an item record in a list of item records to a private set of users.

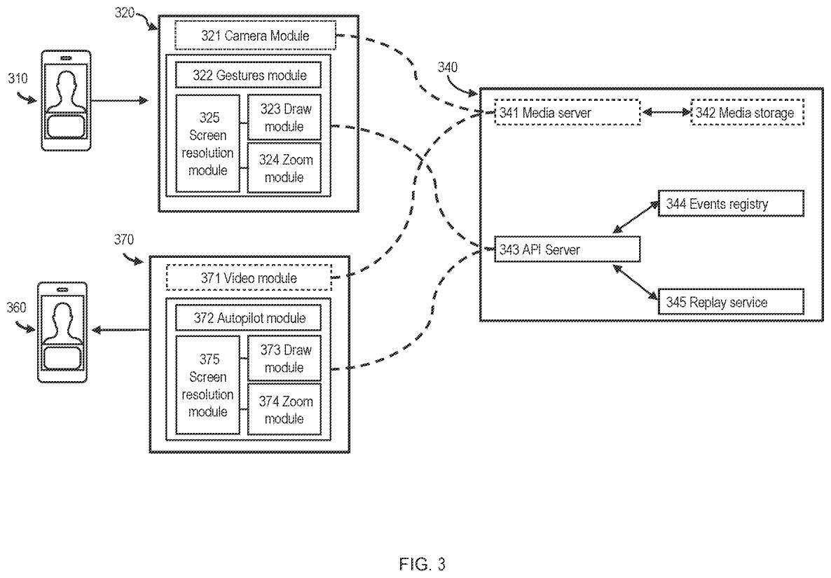

FIG. 3 shows a conceptual diagram of a system infrastructure through which a presenting device may provide content to a viewing device, in accordance with one or more embodiments. A presenting device 310 may execute a presenting application 320, where the presenting application 320 may include or use application modules, such as a camera module 321, a gesture control module 322, a zoom module 324, a screen resolution module 325, etc. In some embodiments, the camera module 321 may be used to obtain image data that is to be presented to one or more other devices. The image data may include a set of images, a set of video data, a set of brightness values, a set of coloration values, etc. For example, some embodiments may use the presenting application 320 by activating the camera module 321 to capture streaming video data. The streaming video data may then be presented to a viewing device 360 via a server or other computing device using operations described in this disclosure. Some embodiments may track a user's interactions with the presenting device 310 by using the gesture control module 322. For example, some embodiments may use the interaction tracking module 322 to track a user's swipes, taps, other hand motions, facial expressions, voice commands, or other interactions that may cause the presenting application 320. The tracked interactions may cause a change in an appearance of a UI screen being presented by the presenting application 320 or a viewing application 370 of the viewing device 360.

Some embodiments may record drawn paths or other drawing information by using the draw module 323. The draw module 323 may track the hand motions of a user or other gestures of the user and convert the tracking information into drawing information, such as paths, shapes, points, etc. Furthermore, some embodiments may use the zoom module 324 to track a zoom factor or position offset while detecting a drag event. Alternatively, or in addition, some embodiments may use a screen resolution module 325 to provide screen information about a screen of the presenting device 310, where the screen information may include a screen type of the screen, dimensions of the screen, a screen resolution, etc.

Some embodiments may send data from the presenting application 320 or other applications executing on the presenting device 310 to a computer system 340. The computer system 340 may include a backend server, a cloud computing system, or another computer system. Some embodiments may receive data from the presenting application 320 and determine where to store the data based on the data type. For example, some embodiments may store video, audio, images, or other media data in a media server 341. Some embodiments may use the media server 341 to manage or record a media stream, where the media stream may include an audio stream or a video stream. Some embodiments may transfer or otherwise access a media storage 342 of the media server 341. The media storage 342 may be used to store video data, music, etc.

Some embodiments may receive requests, instructions, or other messages at an API server 343 from the presenting device 310 or the viewing device 360. Some embodiments may use the API server 343 to access an events registry 344. For example, some embodiments may access a list of events recognized by a system and stored in the events registry 344, where such events may include a user's activation of UI elements, a user's motions, users text input, other types of inputs, notifications, etc. Alternatively, or in addition, some embodiments may use a replay service 345 to provide data representing the stored events representing actions taken by a user on the presenting device 310 to a viewing device 360. Some embodiments may update one or more UI screens, or update resources used to generate the UI screens described in this disclosure, or otherwise perform one or more operations described in this disclosure based on the data stored or obtained via the replay service 345 to emulate a user action taken by a user on the presenting device 310. For example, some embodiments may retrieve map data, weather data, pricing data, or other data from a third-party data source.

Some embodiments may provide data to the viewing device 360, where the viewing device 360 may receive the data and provide the data to a viewing application 370. In some embodiments, the viewing application 370 may include a video module 371 to play video data provided by the presenting application 320. In some embodiments, the data may be video data, such as a video stream provided in real-time with the camera module 321 or another module of the presenting application 320. Some embodiments may perform operations corresponding with modules of the viewing application 370, such as an autopilot module 372, a draw module 373, a zoom module 374, or a screen resolution module 375. In some embodiments, the autopilot module 372 may be used to simulate gestures, commands, text input, or other types of inputs provided to presenting device 310 and recorded in the events registry 344.

Some embodiments may record the activation, use, or deactivation of different modules of UI elements, data retrieval operations, data processing operations, or data presentation operations of the presenting application 320 and save the recording as a time-ordered sequence of events using the replay service 345. In some embodiments, the computer system 340 may then provide the autopilot module 372 with the time-ordered sequence by retrieving a time-ordered sequence of events data using the replay service 345. After receiving the time-ordered sequence, the autopilot module 372 may update the UI of the viewing application 370 by simulating interactions that a user had with the presenting application 320 on the viewing application 370 or recreating the effects of those interactions on the viewing application 370. For example, some embodiments may animate or highlight UI cards, replicate the drawing of figures on the UI, display user inputs that a user of the presenting application 320 had entered into the presenting application 320, replay a zooming event, replay a dragging event, etc. Some embodiments may use one or more functions or subroutines of the autopilot module 372 to update a UI displayed by the viewing application 370. For example, some embodiments may use the autopilot module 372 to reconstruct gestures performed by a user on a presenting device. The effect of such gestures may include UI card movement, zooming on a UI screen, how many cards are scrolled, etc.

Furthermore, some embodiments may update the concurrently with the presentation of video data. For example, some embodiments may receive media-event stream data from the presenting application 320 and determine that a first time interval has been reached based on a timepoint of a received time-ordered sequence of events. In response to determining that the timepoint had been reached, some embodiments may then use the autopilot module 372 to activate a UI element based on instructions or parameters stored in the time-ordered sequence of events. For example, a user may interact with the presenting application 320 by moving UI cards at a first timepoint, opening a map module at a second timepoint, and expanding a photo at a third timepoint while recording the events, where each timepoint may be stored relative to the start of the recording. In some embodiments, the recording may include a video recording or audio recording. Some embodiments may transmit these events to a backend API of the computer system 340, where the events may be stored in a sequence of events that indicates information such as user-caused card movement of cards. Some embodiments may then transmit the sequence events to the viewing application 370, which would then use the autopilot module 372 to cause the UI card movement at the first timepoint, cause the opening of the same map at the second timepoint, and cause the expansion of the photo at the third timepoint. Some embodiments may send the set of events concurrently with the video data or audio data, where the events may be performed concurrently with the video data or audio data at a corresponding timepoint. Alternatively, some embodiments may present the video, audio, or other media data from a record while the user may adjust the events in a de-synchronized fashion from media being presented in real time or media being presented from a record. For example, some embodiments may independently present media while permitting a user to interact with cards, interact with widgets presented in the context of a card, etc. For example, some embodiments may obtain a set of widget-related values in real time from an in-system server, a third-party server, or other data source. Some embodiments may then present the set of widget-related values in a widget or otherwise update a widget being presented on a computing device in real-time based on the set of widget-related values.

In some embodiments, the draw module 373, the zoom module 374, or the screen resolution module 375 may perform operations similar to or the same as those of the draw module 323, the zoom module 324, or the screen resolution module 325, respectively. Additionally, or alternatively, some embodiments may use the autopilot module 372 to control the draw module 373, zoom module 374, or the screen resolution module 375 to simulate actions performed by a user of the presenting application 320. For example, some embodiments may determine vertical and horizontal screen resolution values and provide the vertical and horizontal screen resolution values to the screen resolution module 375 of a viewing application 370. Some embodiments may use the vertical and horizontal screen resolution values to reduce the effects of differences in screen resolution between a presenting device's screen a viewing device's screen when the viewing device is reconstructing UI appearance operations such as changing a zoom on UI cards, determining a draw path, highlighting a screen section, etc. In some embodiments, an Autopilot module 372 of the viewing application 370 may get events representing UI-related actions (move cards, draw path, etc.) from an API Server 343 and initiate a Draw module 373 with a Zoom module 374. The algorithm used by a Screen resolution module 375 may be used to calculate coordinates for display on a viewing device 360 for the Draw module 373 and the Zoom module 374 in a ratio corresponding with the viewing device's screen.

As described above, some embodiments may use the screen resolution module 375 to reproduce one or more user interactions. For example, some embodiments may use a screen resolution module 375 to detect that a viewer's screen width is 500 pixels and that the viewer's screen height is 100 pixels. Some embodiments may store point coordinates in an X:Y ratio format and may store ratios such in the form of converted points, such as set 0.3:0.25, 0.5:0.425, 0.839:0.5495. Some embodiments may then use the draw module 373 or another module available to the viewing application 370 to calculate a corresponding set of viewer device coordinates based on formulas (1) or (2) below:

CoordinateX=ScreenWidth*RatioPointX (1)

CoordinateY=ScreenHeight*RatioPointY (2)

As shown in the formulas above, CoordinateX may represent a position in a viewing application in the horizontal direction, CoordinateY may represent a position in a viewing application in the vertical direction, ScreenWidth may be the screen width of a viewing device (e.g., a screen width of 500 pixels), ScreenHeight may be the screen height of a viewing device (e.g., a screen height of 100 pixels) formulate, and where each coordinate value may be rounded to a nearest pixel value. For example, some embodiments may implement Equations (1) and (2) to determine [CoordinateX:CoordinateY] values based on a screen width of 500 pixels, a screen height of 100 pixels, and a set of ratios [0.3:0.25], [0.5:0.425], [0.839:0.5495] will get 150:250, 250:425, 419.5:549.5 pixel points. Some embodiments may perform such calculations to reproduce, on a viewing device, a zoom event, a draw event, or another such event first performed on presenting device.

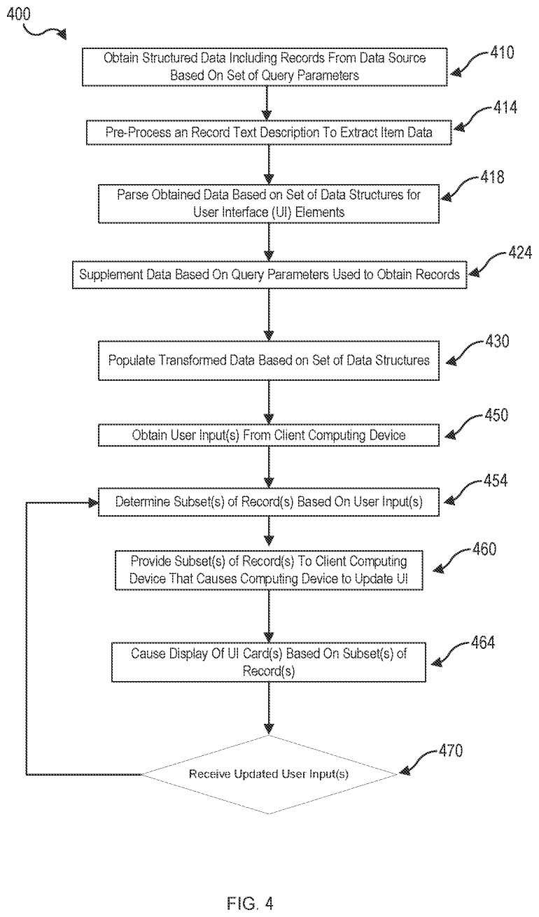

FIG. 4 shows a flowchart of a process to obtain item values, parse the item values based on a set of data templates, and present the item values in the form of UI cards, in accordance with one or more embodiments. Operations of the process 400 may begin at block 410.

Some embodiments may obtain structured data that includes records from a data source based on a set of query parameters, as indicated by block 410. Some embodiments may obtain structured data from a client computing device, an on-premise server, a remote server, a distributed computing system, a cloud computing system, etc. For example, some embodiments may obtain structured data in the form of an ordered set of item records from a third-party data source by sending a request to the third-party data source, where the request may include a query. Some embodiments may then receive the structure data from the third-party data source and perform processing operations on the obtained data.

Some embodiments may cause a data source to provide the structured data by sending the data source a query, where a query includes a set of query parameters. For example, some embodiments may obtain data from a database by providing an API of the database with a query or parameters of a query. A query may be submitted to a local data source, network-connected data source, or a third-party data source, where the query may be written as a SQL query, a graphQL query, or another type of query. In some embodiments, a query may include domain-specific parameters, where a domain include table features specific to a table or set of tables. For example, some embodiments may use query parameters specific to a hotel domain or travel domain, such as a room cost, hotel rating, user-specific value, number of people, room location, or the like. A query parameter may include a feature name, a numeric value, a value representing a category, a Boolean, etc. For example, some embodiments may send a query to an API of a server that includes the query parameter “maximum occupants” and “50.” Furthermore, some embodiments may store a condition as a query parameter, such as storing ‘[“maximum occupants”>50]’ as a query parameter.

Some embodiments may perform pre-processing operations on the obtained structured data, as indicated by block 414. The preprocessing operations may include recognizing values of the structured data as associated with other values, filtering the structured data based on a set of criteria, sorting the structured data, aggregating values of the structured data, deduplicating values or records, or performing other preprocessing operations. For example, some embodiments may perform operations such as determining that a first item record and a second item record share a same set of values for a set of specified record attributes. In response, some embodiments may associate the first item record and the second item record with each other. For example, some embodiments may determine that a first record and a second record have a same hotel address and a same hotel room type, where the first record includes a first set of additional values not present in the second record, and where the second record may include a second set of additional values not present in the second record. In response, some embodiments may aggregate the first and second records into one aggregated record, where the aggregated record includes the first set of additional values and the second set of additional values. As described in this disclosure, aggregating a plurality of records may include adding values of the records into one of the plurality of records or generating a new record that includes values of the plurality of records.

Various pre-processing operations may be domain-specific, where a domain may be defined by the value type of a record, a category value assigned to the record, a data set as a whole, a database, etc. For example, some embodiments may obtain a first set of records from a first database and perform a first set of pre-processing operations, where the first set of pre-processing operations may include aggregating all records of the first set of records sharing a first attribute value. Some embodiments may then obtain a second set of records from a second database and perform a second set of pre-processing operations, where the second set of pre-processing operations may include aggregating the second set of records by a second attribute value without aggregating the second set records by the first attribute value.

Some embodiments may parse the obtained data based on a set of data structures for UI elements, as indicated by block 418. Parsing the obtained data into a set of data structures may include determining, for each record of the obtained data, storing one or more values of the record into a UI-related data structure mapping to a UI element, such as a card-related data structure mapping to a UI card. For example, some embodiments may obtain a first record for an airplane reservation that includes a flight number, airline identifier, starting location identifier, destination identifier, and price value. Some embodiments may then extract the starting location identifier, destination identifier, and price value for storage in a first card-related data structure based on a card-related template, where the card-related template may indicate the type of data to store in the first card-related data structure. Similarly, some embodiments may extract the flight number, airline identifier, and price value for storage in a second card-related data structure based on a second card-related template that indicates the type of data to store in the second card-related data structure. For example, some embodiments may display modular UI elements based on the values of obtained structured data that is parsed into one or more UI-related records. While some embodiments may store data in card-related data structures, some embodiments may store values in other UI-related records that map to other UI elements.

Some embodiments may augment the obtained data based on the query parameters used to obtain the records, as indicated by block 424. In some embodiments, a record or other data obtained from a data source may be augmented with a query parameter or a value derived from the query parameter. Some embodiments may update an item record storing values that are to be displayed in a modular UI element with a query parameter used to obtain the values from a data source. For example, after obtaining structured data based on a set of query parameters that include “geolocation=[41.1400° N, 104.8202° W]” and “radius_km=10,” some embodiments may generate a set of item records from the structured data. Some embodiments may then update the set of item records with one or more parameters of the set of query parameters, such as “[41.1400° N, 104.8202° W]” or “10.”

Some embodiments may store query parameters as a complete statement or as a combination of an operator and a value. Furthermore, some embodiments may generate new features for a record based on query parameters. For example, some embodiments may send a query to a third-party data source with a query parameter “>3” corresponding with a database feature “occupants.” Some embodiments may then augment records retrieved with the query parameter “>3” by adding the feature “occupants” to the retrieved records when generating transformed records with the retrieved records, where the added feature is populated with a generated category value “>3.” By adding additional features to a retrieved record to generate a transformed record, some embodiments may increase the speed of server-side or client-side record retrieval operations.

Some embodiments may update a set of records to indicate different combinations of products or services that satisfy a query parameter. For example, some embodiments may determine that three different combinations of hotel rooms from a hotel satisfy a query parameter based on values (e.g., values representing prices, room accommodations, age limits, etc.) stored in records for the hotel rooms. Some embodiments may then associate the combinations of records with each other and index the combinations with the query parameter, where updating the index based on the query parameter may result in a more efficient search for a later query. Some embodiments may track the prices or another rapidly changing variable associated with records and dynamically update a UI based on the rapidly changing variable.

Some embodiments may populate transformed data based on the set of data structures, as indicated by block 430. In some embodiments, the data obtained from an external data source may not include enough values to populate one or more features of a record, where the feature or corresponding feature values may be used to filter a set of records. For example, a room rate for a hotel booking may be indicated in a corresponding record as being available for two or more guests only, but a room itself may be able to accommodate one guest as well. In response, some embodiments may update records storing data for the room to indicate that the room is also capable of accommodating one guest.

In some embodiments, the third-party data may include geographical location data, a geographic route based on the geographic location, climate data, pricing data, or other values stored in government data sources, publicly-available data sources, or private data sources. For example, some embodiments may populate a card-related data structure for a first UI card type with data obtained from a first data source that includes a name of a hotel, a hotel room, and a location of the hotel, where the data may be stored in a first record. Some embodiments may access a weather database based on the location of the hotel to obtain a set of weather-related records storing weather-related values (e.g., temperature, precipitation percentages, categories representing weather type, etc.). In some embodiments, a linking record of the weather-related records is linked to the first record based on the location of the hotel. In some embodiments, the linking record may be determined to be linked to the first record by having a value that is equal to a value of the first record or within a threshold distance of the first record. Some embodiments may then augment the first record with the set of weather values based on the linking record. Furthermore, after extracting and transforming data with missing options, some embodiments may extract additional data and transform the data into a tree structure usable for later presentation in UI.

In some embodiments, the collected data may include a set of images associated with an item record, where the set of images may be directly associated with the item record or retrieved from other records based on one or more values stored in the item record. For example, some embodiments may obtain a geographical location with the item record, retrieve a corresponding location-specific record based on the geographical location, and obtain the set of images based on the location-specific record. Some embodiments may then store the images in association with the item record or a transformed record generated from the item record. For example, some embodiments may obtain a set of images from an image repository associated with a linking record that was retrieved using a shared feature value. The shared feature value may include values such as coordinates representing a geographic location of a hotel room record. Some embodiments may then generate a transformed record using operations populating features of the transformed record to include at least one value of the first record and at least one value of the linking record. For example, some embodiments may generate a transformed record that includes a name of a hotel record and a geographic route to the hotel record obtained from a third-party record.

After retrieving image data such as single images or video data, some embodiments may associate images of the image data from the image repository with a record based on a machine learning model result. Some embodiments may use a machine learning model such as a convolutional neural network to perform image recognition operations that recognize shapes associated with an item for filtering operations. For example, some embodiments may use a convolutional neural network to filter a set of images to determine which subset of the images should be associated with an item record and which subset of images should not be associated with the item record. Some embodiments may load different neural network parameters based on a category associated with a record, where the category may label the record as a whole or a specific feature(s) of the record.

Some embodiments may obtain a set of user inputs from a client computing device, as indicated by block 450. Some embodiments may obtain inputs such as text inputs, categorical selections, or other inputs. For example, some embodiments may obtain a user's selection of a first identifier representing a first item record and second identifier representing a second item record after the user taps on a set of icons and then taps on a button labeled “submit.” Alternatively, some embodiments may include a set of query parameters usable to filter a set of records to select a subset of records. In some embodiments, the set of inputs may include events representing taps, clicks, voice commands, gestures, facial expressions, etc. For example, some embodiments may obtain a sequence of taps from a client computing device, where the presentation of one or more values may depend on a shape made from the sequence of taps.

Some embodiments may provide data to a client computing device that causes the computing device to present a UI representing an initial state. Some embodiments may provide the data in conjunction with UI presentation program code, such as JavaScript code, web assembly code, etc. For example, some embodiments may provide the UI in the form of web assembly code that causes a web browser to display a set of UI cards based on the web assembly code. Alternatively, or in addition, some embodiments may provide data to the computing device without providing additional program code. Pre-existing program instructions executing on the client computing device may receive the data and perform operations based on the pre-existing program instructions to display the data. For example, some embodiments may send an array that includes a first string, a first numeric value, and a second numeric value. After receiving the array, a native application executing on a mobile computing device may execute operations that causes the mobile computing device to present a first UI card to display an image based on the first string and to present a second UI card to display the first and second numeric values.

Some embodiments may determine one or more subsets of a set of records based on the set of user inputs, as indicated by block 454. The subsets of records may be obtained using user inputs as record selection instructions or filters. For example, a user may represent a first item record and provide a set of filters used to generate a query that may cause a database to provide a second record based on the query. Some embodiments may then combine an identifier of the first record with an identifier of the second record to form a subset of records.

Some embodiments may select a set of transformed records based on the set of user inputs, where at least one record is selected based on a shared value with another record. For example, some embodiments may obtain first transformed record that includes data from a plurality of other records. Some embodiments may also select a second transformed record based on a shared value with the first transformed record. The shared value may include a quantity, a set of quantities, a category, text, etc. For example, some embodiments may select a second record based on the second record sharing a same declared city or other shared geographic location as a first record.

Some embodiments may determine the existence of one or more UI-related records associated with an item record. For example, some embodiments may obtain instructions to present data for a first item record, where the first item record is associated with a first UI-related record for a first UI card and a second UI-related record for a second UI card. Some embodiments may then send each UI-related record, to a client computer device. In some embodiments, to conserve bandwidth or other data resources, some embodiments may send UI-related records without sending data from another data source that was parsed or otherwise processed to obtain values of the UI-related records.

Some embodiments may store the subset of records in association with a user account, where the user account may be used to access data stored in one or more records of the subset of records. For example, some embodiments may determine a subset of item records and associate the subset of item records with a first user. In some embodiments, the first user may share or provide permission to access or edit subsets of item records to a second user. For example, some embodiments may receive instructions from a first user to provide, to a second user, a list of identifiers of item records created by the first user.

In some embodiments, the subsets of records may include multiple possible combinations of multiple records based on a set of query parameters provided by a user. For example, some embodiments may obtain a query indicating a set of criteria that may be satisfied by a combination of records. In response, some embodiments may determine a combination of records having attributes that collectively satisfy the criteria. For example, some embodiments may obtain a required number of occupants for a hotel room as part of a query, where the query may include the statement “num_guests=10.” In response, some embodiments may generate a first subset of three records representing three different hotel rooms and a second subset of four records representing four different hotel rooms. The combination of records may be generated based on a determination that the sum of the maximum permitted occupancies of each hotel room for each subset satisfies the criteria, where the maximum permitted occupancies may be stored as values of each rooms' corresponding record. Some embodiments may use data that was added to a record based on search parameters when determining a combination of multiple records that satisfy a later query.

Some embodiments may provide the subset of records to a client computing device, as indicated by block 460. The subset of records may include UI-related records that may be used by a modular UI element to present data. For example, a mobile computing device may obtain a first card-related data structure associated with a first UI card and a second card-related data structure associated with a second UI card from a server. Alternatively, or in addition, a server may provide other types of records or other types of data to a client computing device. The client computing device may then generate UI-related records based on data provided by the server storing or otherwise associated with the subset of records. For example, a mobile computing device may generate a card-related data structure based on values provided by a server, where the card-related data structure may indicate feature values of a first item record that differ from the feature values of a second item record.

Some embodiments may cause the display of a set of UI cards or other UI elements based on a provided subset of records, as indicated by block 464. As described elsewhere in this disclosure, some embodiments may present a set of modular UI elements that display values of a UI-related record or values resulting from the UI-related record. A UI card or other modular UI element may present values stored in a record, an image or video stored in a record, an image or linked to by the record, results determined from values stored in a record, a service component obtained from APIs linked to or otherwise made accessible by a record, etc. Furthermore, presenting the UI may include performing operations such as displaying UI cards in a manner that conforms to a device shape. Furthermore, some embodiments may display related UI cards within a pre-set screen distance of each other, where the related UI cards a subset of UI cards obtained from a search based on a user input.

Some embodiments operating on a client computing device may obtain one or more indicators from a server indicating a feature with differing values. For example, a client computing device may receive data for a first record, a second record, and an indicator of a feature shared by the first record and second record, where the feature values for the feature differ between the first and second records. Some embodiments may display a first UI card that includes the feature value for the feature of the first UI card and display a second UI card that includes the feature value for the feature of the second UI card. In some embodiments, the different feature values of a set of records may be highlighted, circled, enlarged, raised upwards in a list of feature values, or otherwise visually differentiated with respect to other feature values in UI cards for the set of records.

Some embodiments may receive a set of updated user inputs, as indicated by block 470. For example, after providing a first subset of records to a client computing device. In response to receiving a first set of user inputs, some embodiments may obtain a second set of user inputs. The second set of user inputs may represent selections or commands made by a user after the user has viewed and interacted with an updated UI of a client computing device. For example, after a user has viewed a first set of UI cards generated from UI-related records, the user may swipe up or down on a screen of a mobile computing device to focus on a second UI card. Some embodiments may determine that one or more UI cards linked to the second UI card cannot be presented due to a lack of data, in response, the client computing device may send a request to a server interact with a card to select one or more values. The selection may cause the client computing device to send a second message to a server that indicates the selection of another UI-related record.

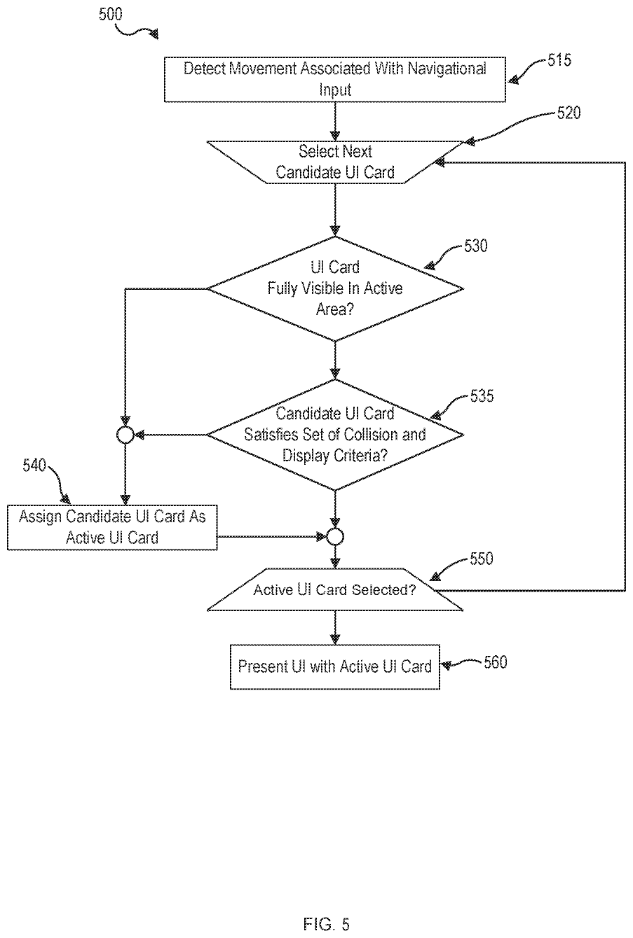

FIG. 5 shows a flowchart of a process to present UI cards based on UI interactions, in accordance with one or more embodiments. Some embodiments may detect movement or other user input associated with a navigational input, as indicated by block 515. Some embodiments may use a set of pre-existing classes of an operating system to detect a navigational input and perform an appropriate update to a UI. For example, some embodiments may detect and perform operations using a UITableview class in the iOS™ system, a ListView class in the Android™ system, or another class recognized by an operating system. For example, some embodiments may determine that a scrolling navigation input is being provided by a user based on a detected swipe upwards on a UI screen. In response, some embodiments may use a method of an instantiated object of the UITableview class of an iOS™ device.

Some embodiments may perform different navigational operations based on the detected movement. For example, some embodiments may detect a vertical motion or horizontal motion on a UI presentation, such as from a user swiping a screen in a vertical or horizontal direction, respectively. In response to detecting vertical movement, some embodiments may present different sets of UI cards, where horizontal rows of UI cards may share a category, and where one or more sets of the different sets of UI cards may have different categories with respect to each other. For example, in response to detecting a vertical or near-vertical swipe (e.g., within 25 degrees of a vertical direction), some embodiments may scroll a UI presentation to display at least one new UI card that displays value, images, or other data stored in or otherwise associated with a new item record that is different from another item record. Furthermore, in response to detecting horizontal or near-horizontal swipe (e.g., within 25 degrees of a horizontal direction), some embodiments may scroll a UI presentation to display at least one new UI card that displays value, images, or other data stored in or otherwise associated with an item record.

Some embodiments may perform operations in a loop for a set of candidate UI cards by selecting a next candidate UI card of the set of candidate UI cards, as indicated by block 520. Some embodiments may loop through the set of candidate UI cards to perform one or more operations described or otherwise indicated by block 530, block 535, block 540, or block 550. As described elsewhere in this disclosure, some embodiments may select a candidate UI card and perform operations based on the candidate UI card until an active UI card is selected. Furthermore, each candidate UI card may be selected from the set of visible cards displayed on a user interface, where a UI card may include or be associated with a value, category, or another type of indicator to indicate that at least a portion of the UI card is being displayed on a UI.

Some embodiments may select the set of candidate UI cards in sequence based on an orientation of the UI being displayed to a user on a computing device. For example, some embodiments may sort a set of UI cards by their display order, where the display order may be set by default or selected by user input. The display order may include an alphabetical order determined from the title of a card, an ascending quantitative score (e.g., a price, a distance, a time), a descending quantitative score, or another type of sequential order. Some embodiments may pre-filter the selected candidate UI cards based on a determination of which candidate UI cards are being displayed on a UI screen. For example, some embodiments may determine a set of candidate UI cards and filter the set of candidate UI cards into a filter subset by determining which of the candidate UI cards are actually being displayed on a UI screen. Furthermore, some embodiments may sort the UI cards such that the first UI card of the filtered subset is the top-most UI card displayed on a UI screen and that the last card of the filtered subset is the bottom-most UI card displayed on the device screen.

Some embodiments may determine whether a fully visible UI card is displayed in an active area of the UI screen, as indicated by block 530. A UI screen may include an active area, where the active area may be a predefined region of the UI screen. For example, the active area of a UI screen may include the region of the UI screen that is centered at the center of the UI screen and covers a rectangular area that is at least 30% of the height of the UI screen and at least 40% of the width of the UI screen. Other dimensions of an active area are possible, where an active area may have a height that is less than 100% of the height of a UI screen and may have a width that is less than 100% of the width of the UI screen. For example, the active area of a UI screen may include the region of the UI screen that is centered at the center of the UI screen and covers a rectangular area that is at least 50% of the height of the UI screen and at least 50% of the width of the UI screen.

Before, during, or after obtaining a navigational input, some embodiments may determine a set of active UI cards displayed on a UI of a computer device based on an active area. An active UI card may include a UI card within an active area. Some embodiments may execute functions, subroutine, or other operations indicated as caused by, displayed on, or otherwise associated with an active UI card. Furthermore, some embodiments may prevent the execution of functions, subroutines, or other operations associated with an inactive UI card, even if the inactive UI card is also partially or fully displayed on a UI screen. For example, some embodiments may show animations, present videos, execute API components within the UI card, display widgets, etc. Additionally, some embodiments perform operations in response to on UI interactions on an active card that would not be performed in response to UI interactions for an inactive UI card.

Some embodiments may determine that a candidate UI card is a fully visible UI based on a determination that a set of card positions of the candidate UI card characterizing the borders of the UI card is within an active area. Some embodiments may determine that a card position may include obtaining a coordinate, where the coordinate may represent a normalized position or a non-normalized position on a screen of a mobile computer device. Some embodiments may determine that the coordinate is within an active area and, in response, determine that the UI card is active. Alternatively, or in addition, some embodiments may determine a plurality of coordinates for the device representing corners, edges, or other boundaries of a UI card and determine whether the UI card is within an active area based on the plurality of coordinates.

In some embodiments, the borders of a UI card may be visible. Alternatively, the UI card may include borders that are invisible to a viewer and defined by hidden values or properties of the UI card. Some embodiments may perform operations to determine Whether the borders of the UI card are within the boundaries of the UI screen. Based on a determination that the borders of the UI card are fully within the active area, some embodiments may proceed to operations described by block 540. Otherwise, some embodiments may proceed to operations described by block 535.

Some embodiments may determine whether a selected candidate UI card satisfies a set of collision or display criteria, as indicated by block 535. A collision between two objects may be detected when a portion of a first displayed object occupies a same region of a UI screen as at least a portion of a second displayed object. For example, some embodiments may determine that a set of collision criteria is satisfied by a candidate UI card when the candidate UI card is determined to collide with an active area of a UI screen.

Alternatively, or in addition, some embodiments may include a set of criteria requiring that that an embodiment determine that a first candidate UI card occupy the greatest area of a UI screen or greatest area of an active area in comparison to other candidate UI cards in order to label the first candidate UI card as an active UI card. For example, some embodiments may determine that a first candidate UI card collides more with an active area than any other candidate UI card. Some embodiments may make such a determination by measuring the collision area of each candidate UI card with respect to an active area and selecting the first candidate UI card based on a determination that the first candidate UI card is associated with the greatest collision area.

Some embodiments may assign the candidate UI card as an active UI card, as indicated by block 540. Assigning a candidate UI card as an active UI card may include modifying a property of a UI or otherwise updating a state value associated with the presentation of data on a UI screen. In some embodiments, only one card of a set of UI cards may be assigned as an active UI card. For example, some embodiments may assign a first card of a plurality of UI cards as an active card, where operations to set only a single card as an active card may permit card functionality for certain devices, such as devices that restrict the number of APIs being accessed or threads to be used by an application. Alternatively, or in addition, some embodiments may assign multiple cards as active UI cards. For example, based on a determination that multiple cards are fully visible in an active area using operations similar to or the same as those described by block 530, some embodiments may indicate that each card of the multiple cards is an active UI card. As described elsewhere in this disclosure, assigning a card to be an active UI card may include dynamically updating data displayed in the active UI card or data otherwise associated with the active UI card.

Some embodiments may determine whether an active UI card has been selected, as indicated by block 550. As described elsewhere in this disclosure, some embodiments may loop through one or more operations described in this disclosure to find an active UI card. For example, some embodiments may loop through one or more operations described by blocks 520, 530, 535, 540, or 550 to assign a candidate UI card as an active UI card. Some embodiments may stop searching for an active UI card after one candidate UI card has been assigned to be an active UI card using operations similar to or the same as those described by block 540. Alternatively, some embodiments may continue looping through a set of candidate UI cards to assign multiple candidate cards to be active UI cards.

Some embodiments may display an updated UI based on the assigned active UI cards, as indicated by block 560. Some embodiments may perform operations associated with an active UI card without performing such operations for a UI card not indicated to be an active UI card. Such operations may include record-updating, color changes, animations, calculations, etc. For example, some embodiments may determine that a first UI card is an active UI card and that a second card is not an active UI card. In response, some embodiments may execute a first script or subroutine associated with the first UI card and not execute a second script or subroutine associated with the second card. The first script or subroutine may cause a client computing device to perform various operations, such as presenting an animation in the first UI card, playing a video in the first UI card, retrieving data from a third-party data source, or actively pushing data to a server. For example, some embodiments may play a video and actively update a price value within a UI card indicated to be an active UI card.

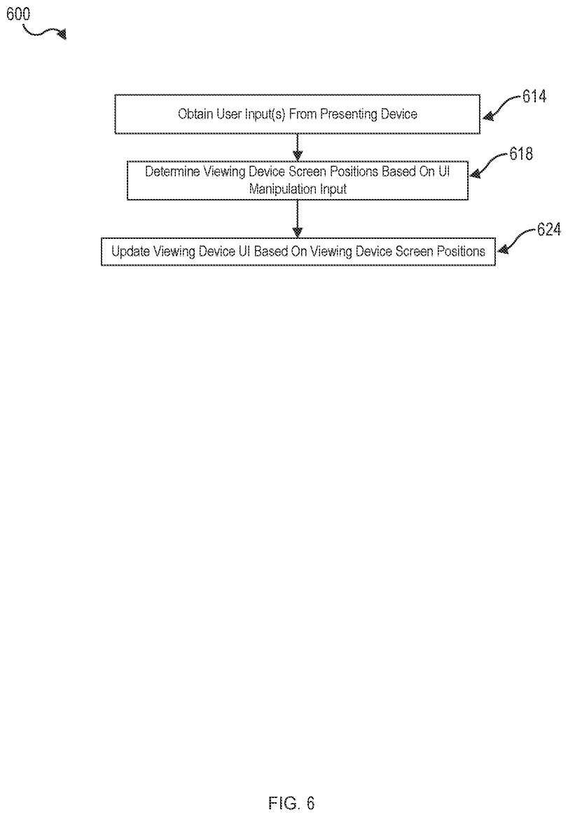

FIG. 6 shows a flowchart of a process to present video streaming data to a viewing device, in accordance with one or more embodiments. Some embodiments may obtain a set of user inputs from a presenting device, as indicated by block 614. Some embodiments may receive inputs from a user that cause updates to a UI screen. For example, a user on a presenting device may select widgets from a widget library to be used on a UI card. A viewing device that is viewing content provided by the presenting device may then display a dedicated widget. In some embodiments, a user of the viewing device may then interact with the dedicated widget to perform a set of operations triggered by the interaction with the widget. In some embodiments, a presenting user may send instructions to a server to display a widget to viewing users, where a widget may include a UI to send votes, button groups, input features, a calculator-displaying UI screen, a weather displaying UI screen, a calendar, etc. Some widgets may also transmit user gestures associated with the widget.

Some embodiments may obtain time-based media such as video or audio media from the presenting device, where one or more inputs may be stored as events associated with a timepoint of the presenting device. For example, after pressing on a widget during a video recording at the “t=53112” timestamp of the video recording, some embodiments may store widget interaction as an event associated with the “t=53122” timestamp. Some embodiments may store the event as a request sent to an API of the widget. Alternatively, or in addition, some embodiments may store an event as a detected interaction at a relative screen position on the presenting device's screen. For example, some embodiments may store a drawing event or zooming event as a sequence of screen positions in the horizontal and vertical coordinates.

Some embodiments may determine a set of viewing device positions based on the UI manipulation input, as indicated by block 618. For example, some embodiments may use an algorithm to calculate a ratio between intercepted coordinates and screen size based on Equations 3 and 4 below. As used in Equations 3 and 4, “RelativePositionX” may represent a relative screen coordinate in the horizontal direction, “PointEventX” may represent the horizontal position of a tap, drawing, or another type of user interaction on a presenting device, “ScreenWidth” may represent the screen width on the presenting device, “RelativePositionY” may represent a relative screen coordinate in the horizontal direction, “PointEventY” may represent the vertical position of the tap, drawing, or another type of user interaction on the presenting device, “ScreenHeight” may represent the screen height on the presenting device:

RelativePositionX=PointEventX/ScreenWidth (3)

RelativePositionY=PointEventY/ScreenHeight (4)

Some embodiments may use a screen resolution module to determine a screen ratio for a Draw module and a zoom module. For example if a UI screen width and screen height of a presenting device is 1000 pixels and 2000 pixels, respectively, and if a user drew a path from a first screen coordinates [300 pixels, 500 pixels], to the coordinates [500 pixels, 850 pixels], and then to the coordinates [839 pixels, 1099 pixels], the Screen resolution module may calculate a relative screen positions for each of the points of the path by using Equation 3 and 4 above to determine the screen coordinates [0.3, 0.25], [0.5, 0.425], [0.839, 0.5495]. The relative screen positions may then be used by a Draw module, Zoom module, or further sent to an API server to effect appropriately proportional changes on the til of a viewing device.

Some embodiments may determine the set of viewing device positions using a server or cloud-computing service. For example, some embodiments may obtain a video recording and associated set of events with screen position coordinates from a mobile computing device being used as a presenting device. Some embodiments may then determine relative viewing device screen positions based on a set of known viewing device dimensions of a viewing device before sending the relative viewing device screen positions to the viewing device. Alternatively, or in addition, a viewing device may determine relative or absolute viewing device positions using a processor or another computing resource of the viewing device itself after receiving absolute screen positions of the presenting device.

Some embodiments may update a viewing device UI based on the set of viewing device positions, as indicated by block 624. Some embodiments may update a viewing device UI concurrently with a real-time video stream or a previously-recorded video. For example, some embodiments may update the movement of UI cards on a UI based on a set of recorded events that are in sync with a previously-recorded video. Some embodiments may use the relative screen positions associated with recorded events to reconstruct one or more events on the viewing device. For example, after receiving video data and a synchronized set of events that include drawing event coordinates represented as relative device screen positions, some embodiments may reconstruct, on a viewing device, a drawing first made on a presenting device by determining absolute viewing device positions based on the relative device screen positions.

For example, some embodiments may transmit event data indicating a user's interaction with a set of buttons of a calculator widget on a UI screen to display a calculated result of the calculator widget. Some embodiments may receive the event data at a client computing device acting as a viewing device to reproduce the events indicated by the event data in order to display the same calculated result. Various other reconstructions of an interaction with a widget or another UI component may be performed. For example, some embodiments may reconstruct a drawing event over a UI card. Alternatively, some embodiments may receive a set of user-provided values at a viewing device and update a calculator, weather-related application, or other widget based on the set of user-provided values.

In some embodiments, a widget of a UI card or other UI component may connect to an API that obtains context data specific to a device. For example, a first user may interact with a presenting device that causes a weather widget that automatically obtains a geolocation of a device via an operating system function which does not rely on a direct user input. In order to accurately reproduce a presenting device's interactions, some embodiments may store event data that includes one or more context values sent to an API that includes one or more values that was not obtained from a UI screen. Some embodiments may then send the context values to a viewing device, where a reconstructed interaction with a widget on the viewing device may cause the transmission of an API with the same context parameters. For example, if a user of a presenting device interacts with a button on a UI card that causes the transmission of a request to an API that includes a presenting device geographic location, some embodiments may store the event with. the presenting device geographic location. Some embodiments may then send the event with the presenting device geographic location to a viewing device, where the viewing device may use the presenting device geographic location when reconstructing an interaction with the button.

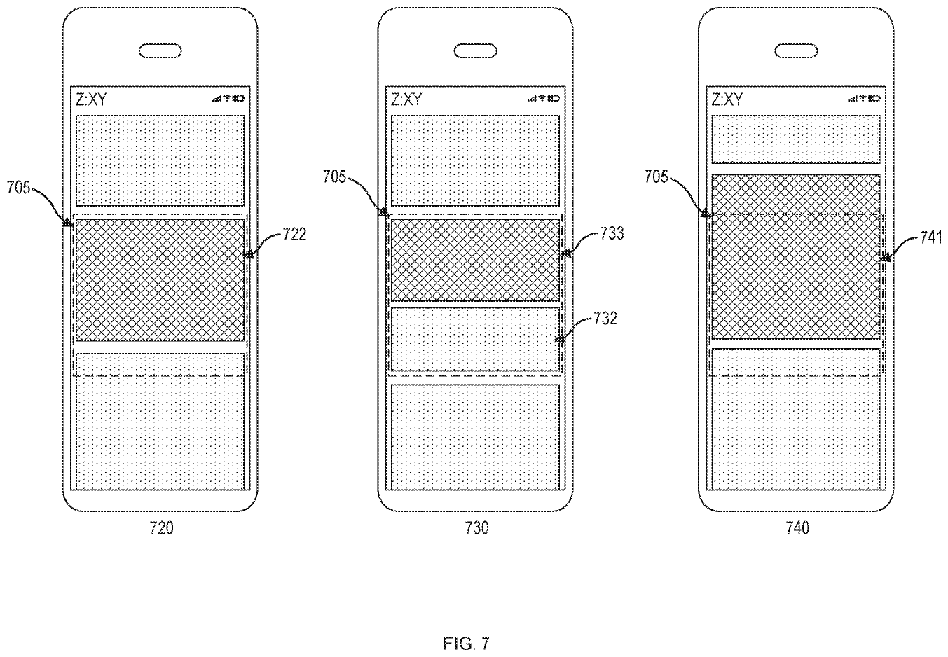

FIG. 7 shows a set of active UI cards, in accordance with one or more embodiments. As described elsewhere in this disclosure, an algorithm may be used to determine which card is an active UI card on a user interface. Furthermore, an active UI card may be distinguished from other cards displayed on a user interface by having animations, scripts, functions, or other operations associated with the UI card being active. Some embodiments may determine whether a card is active based on an active area box 705.

For example, during a video stream or another type of media presentation, several cards may be shown on a screen. A system may associate a certain card with the current time on a timeline of a media-event stream data or corresponding video playback. Some embodiments may obtain or define an active area box 705. The active area box 705 may include a virtual space of a smartphone screen that is used to define an active UI card 722 by colliding with the active UI card 722 (e.g., at least a portion of the active area box 705 and a portion of the active UI card 722 occupy the same screen space). In some embodiments, the size of the active area may include at least half of a UI screen and share a center with the UI screen. While several cards may fit into the active area, some embodiments may select only one card that will be associated with a stream timeline. While a presenting device user is scrolling through cards or other items, some embodiments may implement the algorithm to define an active UI card in a strict order.

As shown by user interface screen 720, some embodiments may determine that a UI card 722 is an active UI card based on a determination that the UI card 722 is completely displayed on the user interface and within the active area box 705. As shown by user interface screen 730, multiple cards including a card 732 and a card 733 may be presented within the active area box 705. Some embodiments may select the UI card 733 as an active card and set the UI card 732 as an inactive based on a determination that the UI card 733 is positioned above other cards within the active area box 705. Alternatively, some embodiments may select both the VI card 732 and the UI card 733 as active UI cards. Alternatively, some embodiments may select a UI card as an active UI card based on a determination that the UI card is the bottom-most UI card or a most-middle UI card. Alternatively, or in addition, in cases where all of the UI cards displayed on a UI are not completely within the active area box 705, some embodiments may perform a calculation to determine which card has the greatest area within the active area box 705. After determining the UI card having the greatest area in the active area box 705, some embodiments may select the UI card with the greatest area in the active area as an active UI card. For example, as shown in a UI screen 740, some embodiments may determine that the UI card 741 has the greatest collision area with the active area 705 and select the UI card 741 as an active UI card.

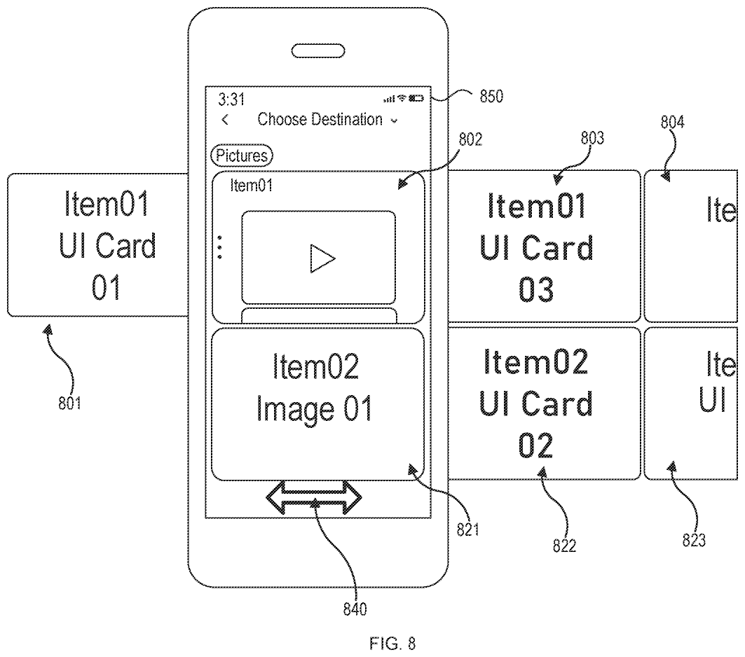

FIG. 8 shows a set of UI screens permitting control of inputs not accessible via a third-party system, in accordance with one or more embodiments, in accordance with one or more embodiments. Some embodiments may present information stored in a set of records by displaying different subsets of the information from a first set of UI cards 801-803 and a second set of cards 821-822, where the first set of UI cards 801-803 and the second set of UI cards 821-822 may include values obtained from card-related data structures.

As shown in the UI screen 850, the presentation of data from multiple records in the form of UI cards may permit a UI screen to efficiently display different values, images, videos, or other data of the multiple records. For example, the UI screen 850 is shown to display information from a first record identified as “Item01” by presenting the UI cards 801-803. the UI screen 850 may also display information from a second record identified as “Item02” by presenting the UI cards 821-823. A user may swipe in the direction indicated by the arrow 840 to present different UI cards. For example, a user may swipe right on UI card 802 to present the UI cards 801 or swipe left on UI card 802 to present the UI card 803. Similarly, a user may swipe left on the UI card 821 to present the UI card 822. Furthermore, a user may swipe upwards on the UI screen 850 to move the UI card 802 and the UI card 803 upwards or swipe downwards on the UI screen 850 to move the UI card 802 and the UI card 803 downwards.

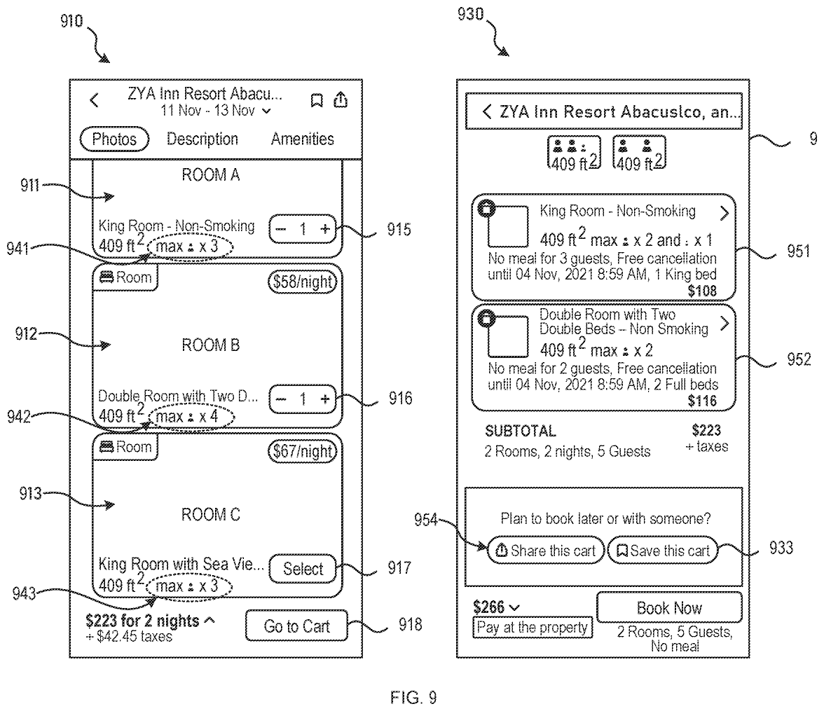

FIG. 9 shows a pair of UI screens with shareable lists of UI elements, in accordance with one or more embodiments. a first UI screen 910 shows a set of UI cards that includes a first UI card 911, a second UI card 912, and a third UI card 913. After receiving a query from a user of a client computing device, some embodiments may obtain a data tree similar to the tree 162 and determine a subset of records based on the nodes of the data tree and the query. Some embodiments may then send data based on the subset of records to a mobile computing device, which may then display the first UI screen 910. Furthermore, some embodiments may determine that the feature values for the feature “max occupancy” differ between different records of the subset of records and generate an indicator for the feature “max occupancy.” A client computing device may configure the UI cards 911-913 to display the icons 941-943 with their corresponding “max occupancy” feature values based on the indicator.

In some embodiments, a user may interact with a first UI element 915 and a second UI element 916 to increase a score representing a number of occupants for item records represented by the first UI card 911 and the second UI card 912, respectively. Alternatively, a user may interact with a third UI element 917 to indicate a selection of an item represented by the third UI card 913. The selection of the item may cause an update to a list of selected records associated with a user record. For example, the selection of the item record represented by the third UI card 913 via an interaction with the UI element 917 may update a list labeled with term “shopping cart” to include an identifier of the item record, where multiple items may be associated with each via the list of items.

In some embodiments, a user may tap on a fourth UI element 918 of the first UI screen 910 to cause a client computing device to transition to a UI screen 930. The UI screen 930 may obtain records based selections made by a user in the UI screen 910 that includes a fourth UI card 951 and fifth UI card 952. The fourth UI card 951 and the fifth UI card 952 may display item record values of the same records represented by the first UI card 911 and the second UI card 912, respectively. In some embodiments, the selection of the records may be stored as a cart record, where the cart record may include a list of item record identifiers, and where the cart record may be created or updated after a user interacts with the UI element 933.

Some embodiments may permit multiple users to update a same cart record. For example, some embodiments may permit a first user that created or is otherwise associated with the cart record represented by the UI screen 930 to share access to the cart record with a second user by interacting with the element 954. The second user may then have access to the cart record such that the UI screen 930 may be updated to include additional UI cards representing additional room records. Alternatively, or in addition, the second user may update feature values shown in the UI card 951 or the fifth UI card 952.

Some embodiments may present a UI element on computing devices of a user associated with a list of item records such that an interaction with the UI element causes the device to perform operations such as pay for items associated with the list of item records or confirm a selection of the list of item records. Furthermore, some embodiments may provide a UI element that permits a permissioned user to associate notes, memos, images, or other information with an item record. For example, a first user may provide permission to a second user to view, edit, or otherwise modify a list of item records represented by the fourth card 951 and the fifth card 952. The user may then make a set of memos or notes for the fourth card 951, the fifth card 952, or both items simultaneously. By providing multiple users with a means of providing feedback for individual item records, comparisons between item records become simpler to present in a UI or analyze.

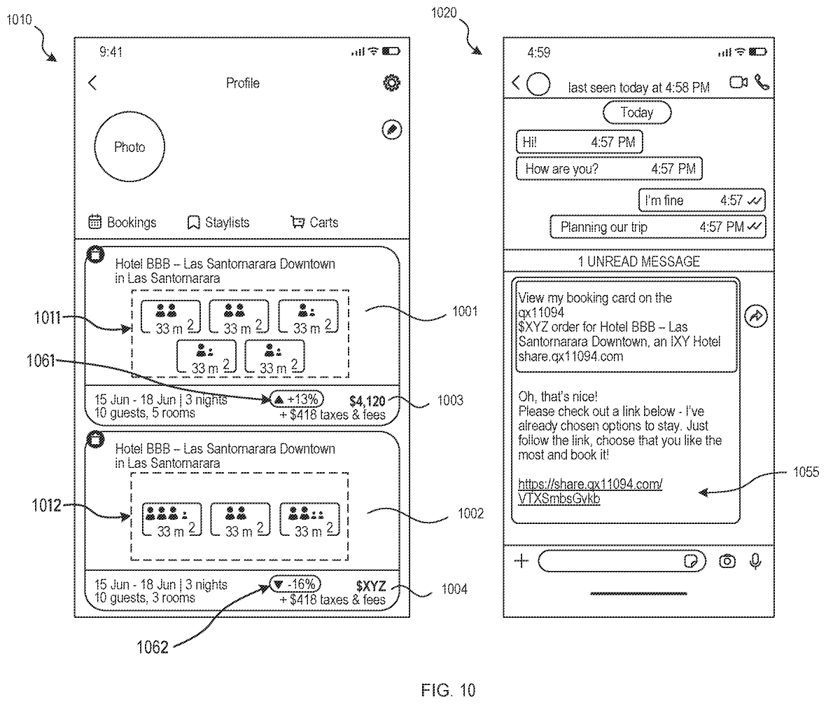

FIG. 10 shows an additional set of interface screens permitting a user to see the various records generated by the user, in accordance with one or more embodiments. Some embodiments may dynamically generate or modify icons to represent attributes of records when displaying an additional set of interface screens. Some embodiments may augment items with icons that visualize differences between different items. For example, a user interface 1010 may display a first UI card 1001 representing a first list of selected records that represents the reservation of five rooms, where each room has a floor space of 33 m², and where the indications are presented in the form of icons. The user interface 1010 further includes a second UI card 1002 representing a second list of selected records, where the icons in the second UI card 1002 indicate a different distribution of individuals through the rooms of the second UI card 1002.

Some embodiments may present the first UI card 1001 and the second UI card 1002 in visual proximity to each other based on a determination that each respective UI card represents a respective set of records that share one or more values. As used in this disclosure, two elements may be within visual proximity to each other if they are within a relative pre-set screen distance (e.g., within 20% of a screen width or 20% of a screen height) or absolute pre-set screen distance (e.g., within 100 pixels, within 50 pixels, within some other number of pixels) of each other. For example, some embodiments may determine that a first set of records represented by the first UI card 1001 is associated with a second set of records represented by the second UI card 1002 based on a determination that a sum of occupants for both the first set of records and the second set of records is equal to the value “10.”

As shown in the first UI card 1001, each room record of the first set of records may be represented by an icon of the first set of icons 1011. Similarly, as shown in the second UI card 1002, each room record of the second set of records may be represented by an icon of the second set of icons 1012. Some embodiments may then display the first UI card 1001 and the second UI card 1002 in visual proximity with each other. Furthermore, the first UI card 1001 may include a price indicator 1003, and the second UI card 1002 may include a price indicator 1004.

Some embodiments may more easily update a plurality of records based on changes to record values by using a tree structure. For example, the user interface 1010 may be dynamically updated in response to real-time or near-real-time monitoring of prices for the two combinations of accommodations shown in the first UI card 1001 and the second UI card 1002. Specifically, some embodiments may receive an update corresponding with a node of a tree and, in response, traverse the tree to update some or all of the records associated with the node. By using a pre-generated tree, some embodiments may avoid requiring a manual request from a user indicating for a value of a record, such as value representing item availability, pricing, etc. Some embodiments may further dynamically update a list of records for a user based on changes in feature values. For example, some embodiment may monitor the availability of items over time and indicate one or more records of a list of records no longer satisfy a requirement that all records are indicated with the feature value “available.” Furthermore, the first UI card 1001 includes a UI element 1061 that shows relative changes to scores for individual item records based on user selections. Similarly, the user interface 1010 includes a UI element 1062 that show a relative change to an aggregate score. The score may represent various types of information associated with an item record, such as a distance, a price, a population count, a physical measurement, etc.

In some embodiments, after selecting a combination of records represented by the first UI card 1001 or the second UI card 1002, some embodiments may display a UI screen 1020. The UI screen 1020 may include a text messaging system selected from various types of text messaging systems, where a user may provide a link to a set of hotel reservation query results, and where a device that is used to access the link may cause the device to display the user interface 1010. Furthermore, after a second user interacts with the hyperlink 1055, the second user may be shown the user interface 1010 with the item options represented by the first UI card 1001 and the second UI card 1002 already pre-selected for booking in one click.

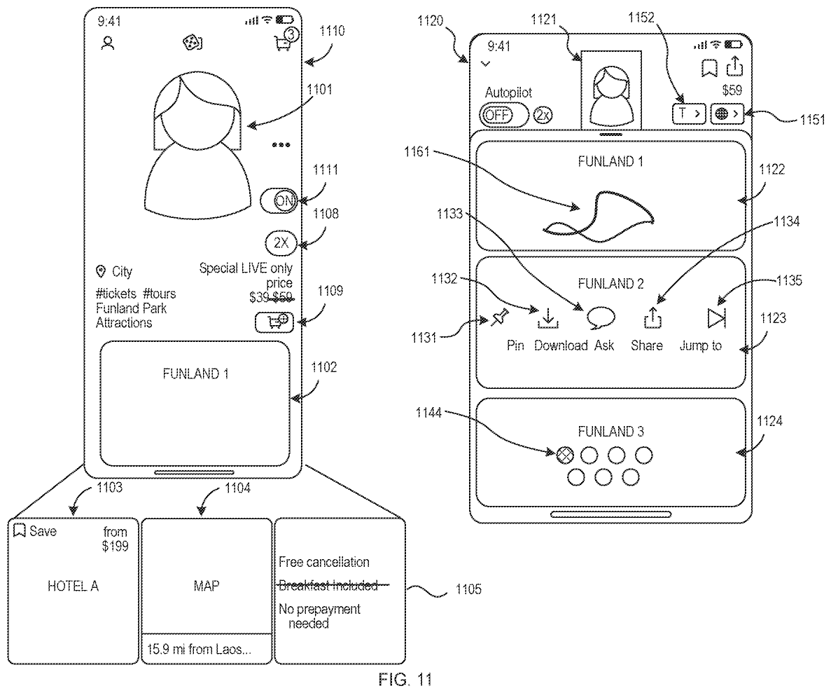

FIG. 11 shows a set of streaming content interfaces, in accordance with one or more embodiments. Some embodiments may augment the presentation of UI cards with time-based media such as a video stream, video recording, audio recording, etc. The augmented time-based media may be presented concurrently with cards that dynamically change in real-time with the time-based media. A user interface screen 1110 shows a video 1101 being presented concurrently with a first UI card 1102 on the user interface screen 1110. As discussed elsewhere in this disclosure, some embodiments may provide a user of a presenting device with the ability to schedule updates to a user interface such as the first UI card 1102.

In some embodiments, a user may swipe the first UI card 1102 to present additional UI cards related to the first UI card 1102, such as a second UI card 1103. The first UI card 1102, the second UI card 1103, or other UI cards may include images, photos, documents, spreadsheets, videos, etc. Furthermore, some embodiments may present a plurality of cards during a video stream.

In some embodiments, a user may update a user interface screen 1110 by interacting with a UI element 1111. In some embodiments, the UI element 1111 may be labeled with the term “autopilot” and associated with activating an operation of an autopilot module, such as the autopilot module 372. An interaction with the UI element 1111 may toggle the value of a UI state variable to enable or disable the operation of the autopilot module. Some embodiments may perform an autopilot module operation to update the presentation of the UI card 1102 to the presentation of the UI card 1103 if the UI element 1111 is set to an “on” state. The time when the update to the UI screen 1110 occurs may be based on a schedule of events associated with the video shown on the user interface screen 1110. Alternatively, if the autopilot feature is not enabled, a UI card that is presented on a UI screen may be presented asynchronously with respect to a video presentation. For example, if the UI element 1111 has been set to the “off” configuration, some embodiments may continue to present the UI card 1102 until a. user manually swipes in a direction to change the presentation of the UI card 1102. In some embodiments, interactions with the UI cards may permit a video, such as the video 1101, to continue without interruption.

The UI screens 1110 and 1120 may include additional UI elements, such as a UI element 1108 or a UI element 1109. In some embodiments, a user interacting with the UI element 1108 may increase or decrease the playback speed of the video 1101. For example, a user may interact with the UI element 1108 to change the playback speed of the video 1101 from “1X” to “2X.” Some embodiments may display one or more UI elements that, when interacted with, update a list of records, a user record, or another set of values associated with a user. For example, a user may interact with the UI element 1109 to update a list of records representing selected items. The list of records may include a general list of items, a shopping cart, a schedule, or some other collection of items. Furthermore, some embodiments may respond to a user swipe in at least one direction of the left, right, up, or down directions of the UI card 1102 by displaying another UI card from the set of UI cards 1103-1105. In some embodiments, each card of the set of UI cards 1103-1106 is associated with the UI card 1102 based on a determination that each record represented by the set of UI cards 1103-1106 shares a feature value with the UI card 1102.

Some embodiments may include various other UI elements on the UI screen 1110 or permit a user to configure the UI screen 1110 to include the various other UI elements. For example, some embodiments may present various icons having a different shape to a user on a UI screen, where an interaction with an icon may cause a client computing device to perform operations such as displaying a web-view of a third-party form, presenting a webpage, or activate additional links to a user. For example, some embodiments may present a UI element depicting an icon that, when interacted with, enables a checkout in a native interface or provide other purchasing options. Some embodiments may present a UI element depicting an icon that provide additional means of communication. For example, some embodiments may launch a mail client to send an email to a specified address, launch a social media messenger application, start a phone call application, etc.

Some embodiments may reconfigure the appearance of the UI screen 1110 to display the UI screen 1120. The UI screen 1120 includes a video 1121 that may include a smaller version of the video 1101. The UI screen 1120 may also display UI cards 1122-1124, where each UI card of the UI cards 1122-1124 may be in different sizes or more UI elements. For example, the UI card 1123 may include a UI element 1131, where an interaction with the UI element 1131 causes the UI card 1123 to be stored in a list of saved context cards. In some embodiments, a user interaction with the UI card 1123 may cause a device to present a dedicated context of the video 1101 associated with the UI card 1123. The UI card 1123 may also include a UI element 1132, where an interaction with the UI element 1132 causes a client computing device to download the content of the UI card 1123. The UI card 1123 may also include a UI element 1133, where an interaction with the UI element 1133 permits a user to comment or ask a question by entering text stored in association with the UI card 1123. For example, UI elements associated with the UI card 1123, such as the UI element 1133, may provide a user with the option to pin a video timestamp, ask a question, share a section of the video associated with the UI card 1123, jump to a section of video associated with the UI card 1123, etc.

The UI card 1123 may also include a UI element 1134, where an interaction with the UI element 1134 causes a client computing device to share a link to the UI card 1123 with another user or another computing device. An interaction with the link may cause a UI screen to navigate to a dedicated section of video associated with the linked card, which may increase utility of link-sharing behavior by presenting the exact context of media being shared. The UI card 1123 may also include a UI element 1135, where an interaction with the UI element 1135 may cause the UI 1120 to skip the playback of the video 1121 to a dedicated section of the video 1121 dedicated to the UI card 1123. In some embodiments, the dedicated section of the video may be determined as starting at a timestamp associated with a next card of the UI card 1123 in a sequence of cards.

Some embodiments may present a UI element that updates the permissions a user to access or edit content, such as updating a user's profile to enable the user to access previously inaccessible functionality. Some embodiments may provide a user with a UI screen 1110 that includes a UI element 1151, where interaction with the UI element 1151 may cause the UI card 1122 to expand or slide upwards. In some embodiments, an interaction with the UI element 1151 (which may be labeled in code or on a UI as a “call to action button” may cause a device to present another UI card that may expand to take up the space of one or more other UI cards. For example, the device may present an expanded UI card that expands until it has covered up UI cards 1122-1124. The expanded UI card may provide functionality related to various types of operations, such as showing an embedded website, providing an embedded dial pad of a phone application to call associated business, present an email form, present a set of ecommerce options, etc. For example, the expanded UI card may In some embodiments, an interaction with the UI element 1151 may provide a set of other UI elements that, when interacted with, may update a record representing a seating arrangement or cause a server to send a message to an API of another computer system.

In some embodiments, any card, such as the UI card 1124 may be responsive. The UI card 1124 may include a widget that is usable while other elements of a UI screen perform other operations. For example, the UI card 1124 may include a widget represented by the set of circles 1144 that is usable while the video 1121 is playing.

In some embodiments, a user may interact with a UI element such as the UI element 1133 to view or edit a set of questions, answers, other text, or other information related a context of a video, audio or other media (e.g., as represented by a timepoint, a UI card, or other data mapped to a section to the media). For example, some embodiments may permit a user to edit questions related to the context of a video section related to the UI card 1123. After detecting interaction with the UI element 1133, some embodiments may present a UI screen that includes a number of questions specific to a UI card or the context of a video regarding the UI card. Some embodiments may store a number of communication messages, video content, and context parameters in association with time-based media, such as an audio file or a video file or the UI card 1123. For example, some embodiments may store a series of text messages and images in association with a specific timestamp of a video file and a specific UI card associated with the specific timestamp of the video file. Some embodiments may permit text, audio, or video communication exchanges between viewing devices and presenting devices in real-time, where such communication exchanges may be stored in a set of databases for later review.

In some embodiments, a first user recording the video 1121 may draw upon a card or another UI element of a UI screen, where other users may then view the same drawing. For example, a first user may draw the shape 1161 on the UI card 1122, where the first user may access a plurality menu that indicates different colors usable to draw the shape 1161. In some embodiments, the drawing may be saved as a set of events indicating relative positions used to generate the shape 1161 and. sent from a first client computing device to a server. The server may then send the relative positions to a second client computing device viewing the video 1121. Once the relative positions or values generated from the relative positions are received at the second client computing device, some embodiments may re-scale the drawings from the relative positions to reconstruct the shape 1161 at the second client computing device. By using relative positions, some embodiments account for screen size differences between the first and second client computing devices, where some embodiments may sync the location of drawn figures at the exact places of cards for users of presenting devices and viewing devices. Furthermore, some embodiments use relative coordinates of interactions on a presenting device to recreate interactions on viewer devices. For example, some embodiments may detect a user interaction with the drawing 1161 to reduce the size of the drawing 1161, where the user interaction is to perform a pinching action. Some embodiments may then send a set of relative coordinates to represent the starting and ending positions of the pinching actions to a second computing device, where the second computing device may then reduce the drawing 1161 being presented on the second computing device by a same relative amount.

In some embodiments, a video may play independently of a user's interaction with a set of cards. For example, after a user swipes left on the card 1102, some embodiments may present a card 1103 without stopping the video 1101. Furthermore, some embodiments may change a video size, increase screen space for UI cards related to a topic, or change other visual features of a UI during the presentation of a video steam, or increase the number of UI cards to be displayed on a client computing device. For example, some embodiments may display a second UI screen 1120. For example, some embodiments may reduce the dimensions of a video 1101 to the video 1121 and increase the dimensions of the first UI card 1102 to present the UI card 1122.

In some embodiments, a user may edit a sequence of cards before a presentation of video data, where sections of the video data may be associated with one or more intervals of time. For example, before recording a video stream for real-time or later presentation, some embodiments may permit a user to configure the set of UI cards 1122-1124 by changing the order of the set of UI cards, replacing a UI card, skipping a UI card, deleting a UI card, etc. Furthermore, a user may modify, add, or delete information associated with a record, such as by adding a location for an item identified by a record, adding an item price, linking to the item on another webpage, etc. For example, once a set of UI cards are added and arranged, a streaming user may begin recording and may interact with cards by zooming on a UI card, performing a draw event a UI card, inputting data into a widget of a UI cards, entering an address on a map-related UI card, choosing a date or destination of a ticket-related UI card, etc. After the streaming user has recorded the video and its associated event data, a viewing user may watch the video, jump to a section of the video associated with a UI card by interacting with a specified UI element, add a text question or associate other information with a UI card, etc. The user may also may interact with a widget of a widget-related UI card (“widget card”) by adding a destination on a map-related widget card, adding a date or location to a ticket-related widget card, etc. In some embodiments user may continue watching the recorded stream while interacting with a widget of a widget card, which may present significant benefits to a user by reducing the cognitive load on a user attempting to follow a video while interacting with a widget.

For example, some embodiments may activate a UI screen to display a map that is accessible via one or more software programs described in this embodiment, where the map may include an icon. The icon may represent a location of a target location on the UI screen. In some embodiments, an interaction with the icon may present a set of values associated with the location, such as crowd density, hours of operation, services offered, etc. Furthermore, the set of values may be updated in real time on a presenting application even when a user is watching a video stream in the presenting application. While the above example is related to location information, other types of real-time updates may be possible, such as stock prices or other information presentable in a widget.

In some embodiments, the UI card 1124 may be responsive, such that the UI card 1124 may be a widget card and an interaction made by a streaming user on their version of the UI card 1124 is not necessarily copied when presented to a viewing user. The viewing user may instead provide their own set of inputs when interacting with a widget of the UI card 1124. An interaction with the icon of the set of circles 1144 or another icon displayed on a may cause the client computing device to perform one or more other operations, such as opening a link, making a phone call, sending an e-mail, sending a text message, checking weather for a selected location, calculating a currency exchange rate for a selected currency, booking a room, obtaining a ticket, etc.

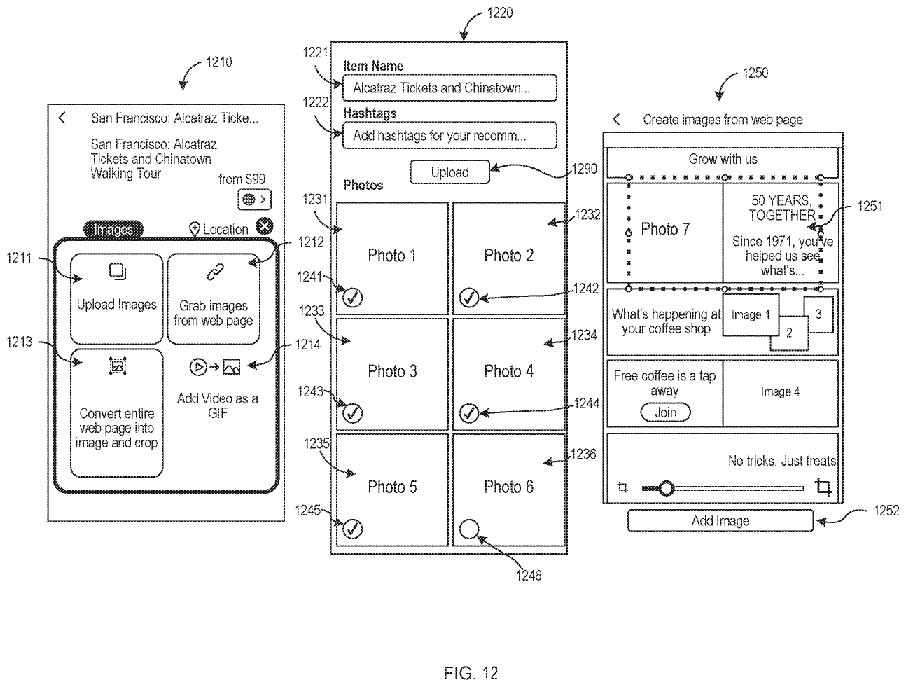

FIG. 12 shows a set of UI elements for the creation of UI cards, in accordance with one or more embodiments. Some embodiments may permit a user to automatically generate cards from the information available about an item online or manually add a UI card or other information for a stream or other presentation. Manually uploaded content may include a photo, video, images, PDF, etc.

The UI screen 1210 includes a UI element 1211, where an interaction with the UI element 1211 causes a client computing device to upload an image to a cud-related data structure for a UI card. The UI screen 1210 also includes a UI element 1212, where an interaction with the UI element 1212 causes a device to retrieve images from a webpage. The UI screen 1210 also includes a UI element 1213, where an interaction with the UI element 1213 may cause some embodiments to convert a webpage into a static image and provide an option to modify the static image. Modifying an image may include cropping an image, enlarging an image, changing the resolution of an image, etc. After the conversion or modification operation, some embodiments may store the image in a card-related data structure for a UI card. The UI screen 1210 also includes a UI element 1214, where an interaction with the UI element 1214 causes some embodiments to incorporate a video into a UI card, where incorporating a video may include embedding a video link, converting the link or an uploaded video into a GIF.

In some embodiments, an interaction with the UI element 1211 may cause an application executing on a computing device to display a UI screen 1220. In some embodiments, the UI screen 1220 includes a UI element 1221, where an interaction with the UI element 1221 may provide a text entry box usable to label a set of images. The UI screen 1220 also includes a UI element 1222, where an interaction with the UI element 1222 causes some embodiments to associate some or all of a set of images to be uploaded with a video stream, with hashtags, or with other category identifiers entered into the UI element 1222. The UI screen 1220 also includes a set of UI elements 1241-1246, where an interaction with each element of the set of UI elements 1241-1246 may cause a corresponding selection of the images in the set of boxes 1231-1236, respectively. For example, some embodiments may determine that the UI element of the set of UI elements 1241-1245 have been checked and that the UI element 1236 has not been checked and, in response to an interaction with the UI element 1290, upload images shown in the set of boxes 1231-1235.

In some embodiments, a user interacting with the UI element 1213 on a computer device may cause the computer device to present a UI screen 1250. The UI screen 1250 may display an image rendering of a webpage and may provide a UI element 1251 that a user may manipulate to crop the image. The UI screen 1250 may also include a UI element 1252, where an interaction with the UI element 1252 may cause some embodiments to select the image section bordered by the UI element 1251 as an image for a card-related data structure, another type of record, etc.

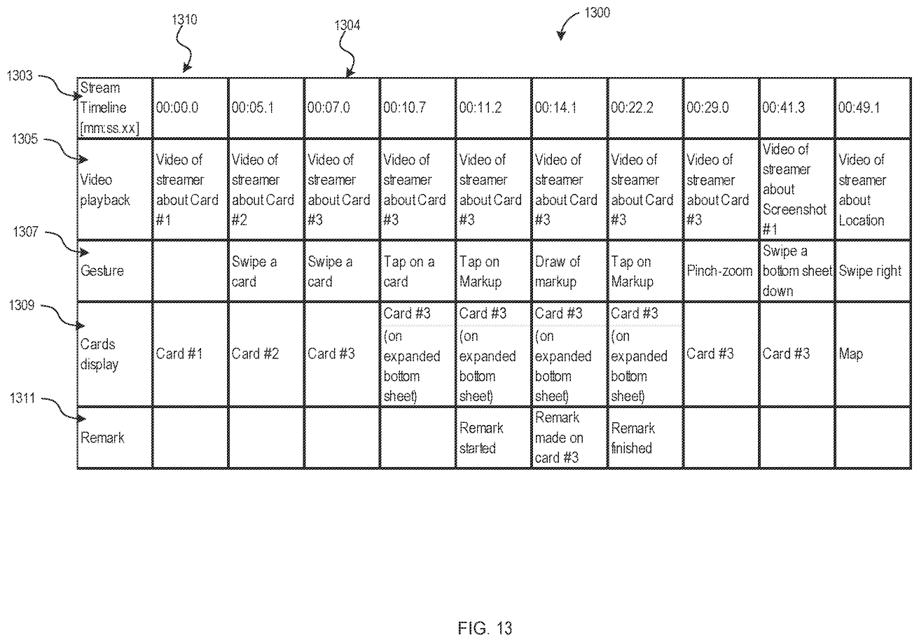

FIG. 13 shows a tabular representation of media-event stream data that occurs through a video presentation, in accordance with one or more embodiments. The tabular representation 1300 is a visual representation of media-event stream data. As described elsewhere, actions performed by a user of a presenting device may be stored in a recording or in association with a recording. Some embodiments may store the actions or effects of the actions as a set of events associated with time-based media and their corresponding relative or absolute timestamp for the time-based media. The set of events in combination with the time-based media may be stored together or separately as the media-event stream data.

Some embodiments may use an API to reconstruct events from the database by sending a set of events via a direct connection to viewer device, where each event may be reproduced on a viewer's display screen at a same relative time as it was originally initiated in a video stream. For example, the time row 1303 may represent a timestamps or time intervals bounded by timestamps, where each column of the table 1300 represents an event that may or may not change the UI on a client computing device in a section other than a video presentation or audio presentation. The media-event stream data may include video data, where the video data may be represented by a video playback data row 1305. The media-event stream data may also include gestures or other actions performed by a user, where the gesture data may be represented by the gesture row 1307. While the cells of the gesture row 1307 are written in text, some embodiments may store gestures as a combination of coordinates or force measurements. As described elsewhere, some embodiments may reconstruct a gesture to change a UI element being displayed on a presenting device or a viewing device. The media-event stream data may also include UI display information, where the UI display information may be represented by the display row 1309. UI display information may include markup formatting, template information, UI state information, or the like. The media-event stream data may also include UI display information, where the UI display information may be represented by the display row 1309. UI display information may include markup formatting, template information, UI state information, or the like. The media-event stream data may also include remarks, where the remarks and time during Which the remarks were made may be represented by the display row 1311.

In some embodiments, a presenting device user's swipe gesture to another UI card, tap on. a UI card, zooming on the UI card or drawings on a UI card may be recorded and stored in a portion of media-event stream data represented by the gesture row 1307. A viewer watching a recorded video stream may interact with a UI element to view the corresponding video for a selected UI card and may further add a remark to the card corresponding with that specific time. Some embodiments may augment the ability to ask a question about a specific section of the stream/specific item disclosed, such as by using the commenting UI element 1133. Furthermore, some embodiments may detect that a video playback is entering a target time interval indicated by media-event stream data corresponding with a corresponding UI card and, in response, present the corresponding UI card.

In some embodiments, a presenting device user may change a displayed UI card, where the change in UI card may be stored in UI display information represented by the display row 1309 in association with a timestamp represented by the time row 1303. Alternatively, gestures made by a user may be stored in a gesture information represented by the gesture row 1307. As shown in the table 1300, ‘mm’ is minutes, ‘ss’ is seconds and ‘xx’ is hundredths of a second for timestamps associated with a certain gesture made, associated card displayed, or a drawing/remark made, where the drawings or remarks may be stored in the remarks row 1311. For example, if user of streaming device swipes to a UI card represented by “Card #3” shown in the column 1304 for the display row 1309, some embodiments may change the UI card on viewing user device represented by “Card #3”. Furthermore, some embodiments may detect that a user of viewing device has changed the UI card “Card #1” to another card, but video playback plays uninterrupted. Some embodiments may detect that a user of viewing device has jumped to the UI card “Card #1” and, in response, a video playback 1305 plays a timeline between the time interval of 00:00.0 and 00:05.1 present based on the information indicated by a column 1310 of the table 1300.

The operations of each method presented in this disclosure are intended to be illustrative and non-limiting. It is contemplated that the operations or descriptions of FIGS. 4-6 may be used with any other embodiment of this disclosure. In addition, the operations and descriptions described in relation to FIGS. 4-6 may be done in alternative orders or in parallel to further the purposes of this disclosure. For example, each of these operations may be performed in any order, in parallel, or simultaneously to reduce lag or increase the speed of a computer system or method. In some embodiments, the methods may be accomplished with one or more additional operations not described, and/or without one or more of the operations discussed. Additionally, the order in which the processing operations of the methods are illustrated (and described below) is not intended to be limiting.

In some embodiments, the operations described in this disclosure may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a non-transitory, machine-readable medium, such as an electronic storage medium. The processing devices may include one or more devices configured through hardware, firmware, and/or software to be specifically designed for execution of one or more of the operations of the methods. For example, it should be noted that any of the devices or equipment discussed in relation to FIGS. 1 and 3 could be used to perform one or more of the operations in FIGS. 4-6.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The computer system 1400 may include one or more central processing units (“processors”) 1405, memory 1410, input/output devices 1425, e.g., keyboard and pointing devices, touch devices, display devices, storage devices 1420, e.g., disk drives, and network adapters 1430, e.g., network interfaces, that are connected to an interconnect 1415. The interconnect 1415 is illustrated as an abstraction that represents any one or more separate physical buses, point to point connections, or both connected by appropriate bridges, adapters, or controllers. The interconnect 1415, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (12C) bus, or an Institute of Electrical and Electronics Engineers (IEEE) standard 1394 bus, also called FireWire.

The memory 1410 and storage devices 1420 are computer-readable storage media that may store instructions that implement at least portions of the various embodiments. In addition, the data structures and message structures may be stored or transmitted via a data transmission medium, e,g., a signal on a communications link. Various communications links may be used, e,g., the Internet, a local area network, a wide area network, or a point-to-point dial-up connection. Thus, computer readable media can include computer-readable storage media, e.g., non-transitory media, and computer-readable transmission media.

The instructions stored in memory 1410 can be implemented as software and/or firmware to program the processor 1405 to carry out actions described above. In some embodiments, such software or firmware may he initially provided to the computer system 1400 by downloading it from a remote system through the computer system 1400, e.g., via network adapter 1430.

The various embodiments introduced herein can be implemented by, for example, programmable circuitry, e.g., one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

With respect to the components of computer devices described in this disclosure, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Further, some or all of the computer devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interfaces nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e,g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., one or more processors performing steps/operations A, B, C, and D) encompass both all such attributes or functions being mapped to all such objects and subsets of the attributes or functions being mapped to subsets of the objects (e.g., both all processors each performing steps/operations A-D, and a case in which processor I performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection have some property should not be read to exclude cases where some otherwise identical or similar members of a larger collection do not have the property (i.e., each does not necessarily mean each and every). Limitations as to sequence of recited steps should not be read into the claims unless explicitly specified (e.g., with explicit language like “after performing X, performing Y”), in contrast to statements that might be improperly argued to imply sequence limitations (e.g., “performing X on items, performing Y on the X'ed items”) used for purposes of making claims more readable rather than specifying sequence. Statements referring to “at least Z of A, B, and C” and the like (e.g, “at least Z of A, B, or C”) refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing time. Thus, updating a record may include generating a record or modifying the value of an already-generated value.

What is claimed is:

1. A method for reducing data consumption for a client-side user interface based on feature differences between transformed records, the method comprising:
obtaining a first item record and a linking record based on a shared feature value associated with the first item record;
determining a first transformed record by populating a first feature of the first item record with a first value of the linking record;
obtaining a second transformed record, wherein the first and second transformed records share a feature set comprising the first feature, and wherein the second transformed record comprises a second value for the first feature that is different from the first value;
sending a set of feature values of the first and second transformed records to a mobile computing device, wherein the set of different feature values comprises the first value and the second value, wherein the mobile computing device performs operations comprising:
selecting the first feature from the feature set based on a determination that the first and second values are different;
in response to selecting the first feature, instantiating a first set of user interface element to comprise the first value for the first feature and a second set of user interface elements to comprise the second value for a second feature based on the set of different feature values; and
presenting a user interface comprising the first set of user interface elements and the second set of user interface elements on a display screen of the mobile computing device, wherein the first set of user interface elements is presented as an first user interface card displaying the first value, and wherein the second set of user interface elements is presented as a second user interface card within a pre-set screen distance of the first user interface card.

2. The method of claim 1, further comprising sending an image associated with the first transformed record to the mobile computing device, wherein:
the first user interface card is located at a first region of the display screen;
the mobile computing devices instantiates a third user interface element to comprise the image or a reference to the image, wherein a visualization of the third user interface element is presented as a third user interface card on the user interface;
a user interaction with the first user interface card in a direction causes the mobile computing device to remove the first user interface card from the first region and present the third user interface card in the first region; and
generating the set of card-related data structures comprises:
parsing values of the first transformed record into a first subset of values and a second subset of values;
generating a first card-related data structure based on the first subset of values and properties of a first card-related template, wherein presenting the first user interface card comprises determining values of the first user interface card based on the first card-related data structure; and
generating a second card-related record based on the second subset of values and properties of a second card-related record template, wherein presenting the second user interface card comprises determining values of the second user interface card based on the second card-related data structure.

3. The method of claim 1, further comprising:
generating a set of card-related data structures based on the first transformed record and the second transformed record, wherein each respective data structure of the set of card-related data structures is associated with a respective user interface card type;
determining the feature set based on features of the set of card-related data structures;
obtaining a set of widget-related values based on the first transformed record; and
providing the set of widget-related values to the mobile computing device, wherein the mobile computing device displays the set of widget-related values.

4. The method of claim 1, further comprising:
providing the shared feature value to an application program interface of a set of servers; and
obtaining a set of widget-related values based on the shared feature value from the set of servers, wherein the mobile computing device displays a widget based on obtained set of widget-related values.

5. The method of claim 1, further comprising:
sending a request to an application program interface of a set of servers;
obtaining a first set of structured data from the set of servers;
generating a tree based on first transformed record and the second transformed record, wherein the first and second transformed records are associated with each other via the tree, and wherein sending the set of feature values of the first and second transformed records to the mobile computing device comprises:
selecting the first transformed record based on a. query parameter; and
selecting the second transformed record based the association between the first and second transformed records indicated in the tree.

6. The method of claim 1, wherein the first set of user interface elements is stored in a card-related data structure, the method further comprising:
obtaining an image based on the first item record; and
updating the card-related data structure to comprise the image and the first set of user interface elements.

7. The method of claim 1, wherein obtaining the first item record comprises obtaining the first item record and a second item record based on a set of query parameters, the method further comprising:
parsing a query into the set of query parameters, wherein each respective query parameter of the set of query parameters may be associated with the first item record;
augmenting the first transformed record with the set of query parameters; and
updating an index of records based on a query parameter of the set of query parameters, wherein an index value associated with the query parameter points to the first item record.

8. The method of claim 1, further comprising providing video data associated with the first transformed record to the mobile computing device, wherein the mobile computing device detects that video of the video data is playing within a target time interval and, in response, displays the first user interface card.

9. The method of claim 13, wherein the target time interval is a first target time interval, and wherein the mobile computing device detects that the video is playing within a second target time interval and, in response, displays a second user interface card, further comprising:
obtaining video data associated with the first transformed record;
detecting that the video is playing within a target time interval; and
in response to detecting that the video is playing within the target time interval, displaying the first user interface card.

10. The method of claim 1, wherein the mobile computing device is a viewing mobile computing device, further comprising:
obtaining a sequence of screen positions from a presenting mobile computing device;
providing the sequence of screen positions to the viewing mobile computing device, wherein the viewing mobile computing device performs operations comprising:
determining a set of horizontal positions based on the sequence of screen positions and a horizontal length of a user interface screen of the viewing mobile computing device;
determining a set of vertical positions based on the sequence of screen positions and a vertical screen resolution of the user interface screen of the viewing mobile computing device; and
updating a visual appearance of the first user interface card or the second user interface card based on the set of horizontal positions and the set of vertical positions.

11. A computer system that comprises one or more processors programmed with computer program instructions that, when executed, cause the computer system to perform operations comprising;
obtaining a feature set from a set of computing devices, wherein the set of computing devices performs operations comprising:
obtaining a first item record and a linking record based on a shared feature value associated with the first item record;
determining a first transformed record by populating a first feature of the first item record with a first value of the linking record;
obtaining a second transformed record, wherein the first and second transformed records share a feature set comprising the first feature, and wherein the second transformed record comprises a second value for the first feature that is different from the first value; and
sending a set of feature values of the first and second transformed records to a mobile computing device, wherein the set of different feature values comprises the first value and the second value;
selecting the first feature from the feature set based on a determination that the first and second values are different;
in response to selecting the first feature, instantiating a first set of user interface element to comprise the first value for the first feature and a second set of user interface elements for the second feature to comprise the second value for the first feature based on the set of different feature values; and
presenting a user interface comprising the first set of user interface elements and the second set of user interface elements on a display screen of the mobile computing device, wherein the first set of user interface elements is presented as an first user interface card displaying the first value, and wherein the second set of user interface elements is presented as a second user interface card within a pre-set screen distance of the first user interface card.

12. The system of claim 11, wherein obtaining the first item record comprises obtaining the first item record and a second item record based on a set of query parameters, and wherein the first transformed record is augmented with the set of query parameters.

13. A non-transitory, machine-readable medium storing program code that, when executed by a computer system, causes the computer system to perform operations comprising:
obtaining a first item record and a linking record based on a shared feature value associated with the first item record;
determining a first transformed record by populating a first feature of the first item record with a first value of the linking record;
obtaining a second transformed record, wherein the first and second transformed records share a feature set comprising the first feature, and wherein the second transformed record comprises a second value for the first feature that is different from the first value;
sending a set of feature values of the first and second transformed records to a mobile computing device, wherein the set of different feature values comprises the first value and the second value, wherein the mobile computing device performs operations comprising:
selecting the first feature from the feature set based on a determination that the first and second values are different;
in response to selecting the first feature, instantiating a first user interface element to comprise the first value for the first feature and a second user interface element for the second feature to comprise the second value for the first feature based on the set of different feature values; and
presenting a user interface comprising the first user interface element and the second user interface element on a display screen of the mobile computing device, wherein the first user interface element is presented as an first user interface card displaying the first value, and wherein the second user interface element is presented as a second user interface card within a pre-set screen distance of the first user interface card.

14. The medium of claim 13, wherein the mobile computing device is a first mobile computing device, the operations further comprising:
receiving streaming video data from a second mobile computing device;
sending the streaming video data to the first mobile computing device concurrently with the receiving of the streaming video data from the second mobile computing device;
receiving first event data and second event data from the second mobile computing device while receiving the streaming video data from the second mobile computing device;
sending the first event data to the first mobile computing device, wherein the first mobile computing device is caused to present a text of the first event data that was entered into the second mobile computing device and concurrently present the streaming video data;
sending the second event data to the first mobile computing device, wherein the first mobile computing device is caused to present a draw event of the first event data that was entered into the second mobile computing device and concurrently present the streaming video data.

15. The medium of claim 14, wherein the mobile computing device performs operations comprising obtaining a set of user-provided values, wherein presenting the user interface comprises updating a widget based on the set of user-provided values.

16. The medium of claim 14, wherein presenting the user interface comprises presenting a third user interface element, wherein an interaction with the third user interface element causes the user to present a third user interface card without removing the third user interface element.

17. The medium of claim 14, wherein the first user interface card and the second user interface card are associated with a same category, and a third user interface element indicates a difference between the first value for the first feature and the second value for the first feature.

18. The medium of claim 14, wherein the first user interface card indicates a selection of item records, wherein the selection of item records comprises the first transformed record.

19. The medium of claim 14, wherein the mobile computing device is a first mobile computing device, the operations further comprising:
receiving a message from a second mobile computing device, wherein the message is associated with the first transformed record; and
sending text data of the message to the first mobile computing device, wherein the text data is associated with the first transformed record.

20. The medium of claim 14, further comprising:
updating a set of records to indicate that a section of video data is associated with the first user interface card; and
sending the set of records to the mobile computing device, wherein the mobile computing device performs operations comprising:
determining that a user has interacted with a third user interface element; and
updating the user interface to present the section of video data.
